(19) United States
(12) Patent Application Publication
(10) Pub. No.: US 2026/0057594 A1
(43) Pub. Date: Feb. 26, 2026

(54) IMAGE GENERATION APPARATUS AND METHOD AND STORAGE MEDIUM

(71) Applicant: CANON KABUSHIKI KAISHA, Tokyo (JP)

(72) Inventors: Yohei MATSUI, Kanagawa (JP); Hideyuki HAMANO, Kanagawa (JP); Akihiko KANDA, Kanagawa (JP)

(21) Appl. No.: 19/295,906

(22) Filed: Aug. 11, 2025

(30) Foreign Application Priority Data
Aug. 20, 2024 (JP) 2024-139155

(51) Int. Cl. G06T 15/00; H04N 23/67; H04N 23/69

(52) U.S. Cl. CPC G06T 15/00; H04N 23/67; H04N 23/69

(57) ABSTRACT

An image generation apparatus includes a generating unit that generates a virtual space image, a first obtaining unit that obtains operation information for a camera of a user, a second obtaining unit that obtain information relating to the camera, a third obtaining unit that obtains information relating to a subject, and a changing unit that changes correction for the virtual space image captured with the camera, based on at least one of the information obtained from the first to third obtaining units.

### BACKGROUND

### Field of the Technology

The present disclosure relates to an image generation apparatus that generates virtual space images.

### Description of the Related Art

The technology described in Japanese Patent Laid-Open No. 2008-78908 enables an image capturing experience without the user needing to go to an image capturing location by combining an image of a 3D-model-based virtual space and an image of an actual space captured by a camera and displaying the combined image.

However, with the technology of Japanese Patent Laid-Open No. 2008-78908, the user can capture a virtual image of a self-selected composition, angle of view, and the like, but control relating to various types of correction for enjoying the image capturing experience is not performed.

The virtual space is all defined by data, and the characteristics, past and future movements, and the like of the subject are known. Thus, because prediction, correction, and similar control can be implemented to a high degree, for example, the user can shoot photos without failure or can perform fully-automated photo shooting.

However, constantly implementing perfect control and correction may lead to a disconnect when compared to the image capturing experience in a real space, which may in turn lead to inhibiting the enjoyment of the act of taking pictures. Thus, so that the photo shooting and image capturing experience in the virtual space is enjoyed, it is necessary to appropriately determine whether to apply correction in accordance with a condition and how much correction to apply, and to switch accordingly.

### SUMMARY

The present disclosure has been made in light of the problems described above and enables realization of an image generation apparatus that enables an enjoyable image capturing experience when shooting in a virtual space.

According to a first aspect of the present disclosure, there is provided an image generation apparatus comprising at least one processor or circuit and a memory storing instructions to cause the at least one processor or circuit to perform operations of the following units: a generating unit that generates a virtual space image, a first obtaining unit that obtains operation information for a camera of a user, a second obtaining unit that obtain information relating to the camera, a third obtaining unit that obtains information relating to a subject, and a changing unit that changes correction for the virtual space image captured with the camera, based on at least one of the information obtained from the first to third obtaining units.

According to a second aspect of the present disclosure, there is provided an image generation method comprising: generating a virtual space image; executing first obtaining to obtain operation information for a camera of a user; executing second obtaining to obtain information relating to the camera; executing third obtaining to obtain information relating to a subject; and changing correction for the virtual space image captured with the camera, based on at least one of the information obtained in the first to third obtaining.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram illustrating the configuration of an imaging system according to a first embodiment of the present disclosure.

FIG. 2 is a block diagram illustrating the configuration of a camera according to the present disclosure.

FIG. 3 is a diagram illustrating a pixel array of a camera according to the first embodiment.

FIGS. 4A and 4B are a plan view and a cross-sectional view of a pixel according to the first embodiment.

FIG. 5 is a diagram illustrating a focus detection area according to the first embodiment.

FIG. 6 is a block diagram illustrating the hardware configuration of an external computation apparatus according to the first embodiment.

FIG. 7 is a block diagram illustrating the functional configuration of the external computation apparatus according to the first embodiment.

FIG. 8 is a flowchart for describing real space shooting and virtual space shooting processing according to the first embodiment.

FIG. 9 is a flowchart for describing real space shooting processing according to the first embodiment.

FIG. 10 is a flowchart for describing image capture processing according to the first embodiment.

FIG. 11 is a flowchart for describing subject tracking AF processing according to the first embodiment.

FIG. 12 is a flowchart for describing subject detection and tracking processing according to the first embodiment.

FIG. 13 is a flowchart for describing virtual space shooting processing according to the first embodiment.

FIG. 14 is a diagram for describing information of a camera/lens information storage apparatus, a camera/lens, and the external computation apparatus according to the first embodiment.

FIG. 15 is a flowchart for describing virtual space image generation and output according to the first embodiment.

FIG. 16 is a flowchart of virtual subject tracking processing according to the first embodiment.

FIG. 17 is a flowchart of shooting difficulty information obtaining according to the first embodiment.

FIGS. 18A to 18F are diagrams for describing correction relating to framing according to the first embodiment.

FIGS. 19A to 19F are diagrams for describing correction relating to zooming according to the first embodiment.

FIGS. 20A to 20D are diagrams for describing correction relating to focusing according to the first embodiment.

FIG. 21 is a flowchart for describing defocus amount editing processing according to the first embodiment.

FIG. 22 is a diagram illustrating a graph of virtual defocus amount calculation according to the first embodiment.

FIGS. 23A and 23B are diagrams illustrating examples of a virtual defocus map according to the first embodiment.

FIG. 24 is a flowchart for describing a subroutine of virtual space shooting according to the first embodiment.

FIGS. 25A and 25B are diagrams for describing virtual space shooting based on operation information according to the first embodiment.

FIG. 26 is a flowchart for describing a subroutine of viewpoint moving processing according to the first embodiment.

FIGS. 27A and 27B are diagrams of examples of viewpoint movement according to the first embodiment.

FIG. 28 is a flowchart for describing camera operation at the time of virtual space shooting according to the first embodiment.

FIG. 29 is a flowchart for describing image capturing result reproduction and captured image evaluation according to the first embodiment.

FIGS. 30A to 30D are explanatory diagrams of defocus map displays according to the first embodiment.

FIG. 31 is an explanatory diagram of an in-focus degree display of a sequence of captured images according to the first embodiment.

FIG. 32 is an explanatory diagram of a settings change list table according to the first embodiment.

FIGS. 33A to 33D are explanatory diagrams of post-evaluation best settings display according to the first embodiment.

FIG. 34 is a flowchart for describing virtual space image generation and output according to a second embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

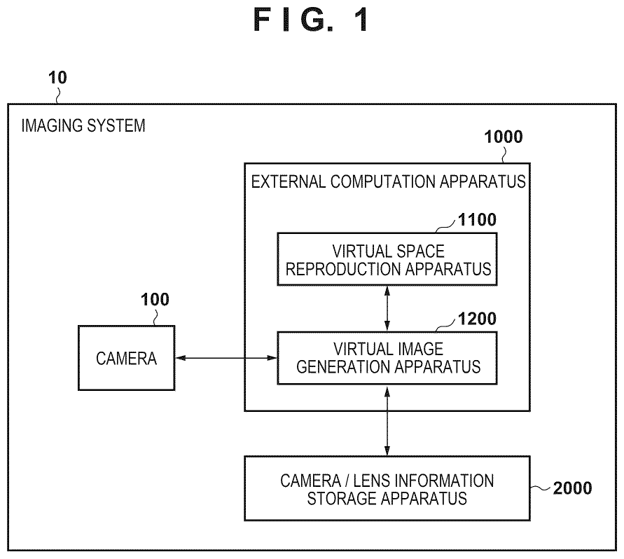

FIG. 1 is a diagram illustrating the configuration of an imaging system 10 including an image capture apparatus, an external computation apparatus (information processing apparatus), and a camera/lens information storage apparatus according to the first embodiment of the present disclosure.

In FIG. 1, an image capture apparatus (camera) 100 includes a function of capturing an image of a subject existing in a real space, a function of instructing image capture of a subject existing in a virtual space, and a function of displaying a captured image. The camera 100 also includes a function as a tactile reproduction apparatus. An external computation apparatus 1000 is connected to the camera 100 via a wired or wireless connection for the exchange of information and includes a virtual space reproduction apparatus 1100 and a virtual image generation apparatus 1200. The virtual space reproduction apparatus 1100 disposes a subject as an object in a virtual space that changes in terms of location and shape from moment to moment in a set virtual space (background space). The virtual image generation apparatus 1200 obtains setting information for the camera and lens, control information, operation information for the operation members, position information including the shooting direction, and the like from the camera 100. Also, related information is obtained from a camera/lens information storage apparatus 2000 using the information obtained from the camera 100. The camera/lens information storage apparatus 2000 may be a server on a cloud or similar network or may be provided in the external computation apparatus 1000.

The virtual image generation apparatus 1200 uses the information obtained as described above to generate (capture) an image from the virtual space constructed by the virtual space reproduction apparatus 1100. The image generated here may be a two-dimensional image or a three-dimensional image including information that can be three-dimensionally displayed. In the configuration illustrated in FIG. 1, the external computation apparatus 1000 reproduces the virtual space and generates the images, but a configuration may be used in which these functions are implemented inside the camera 100.

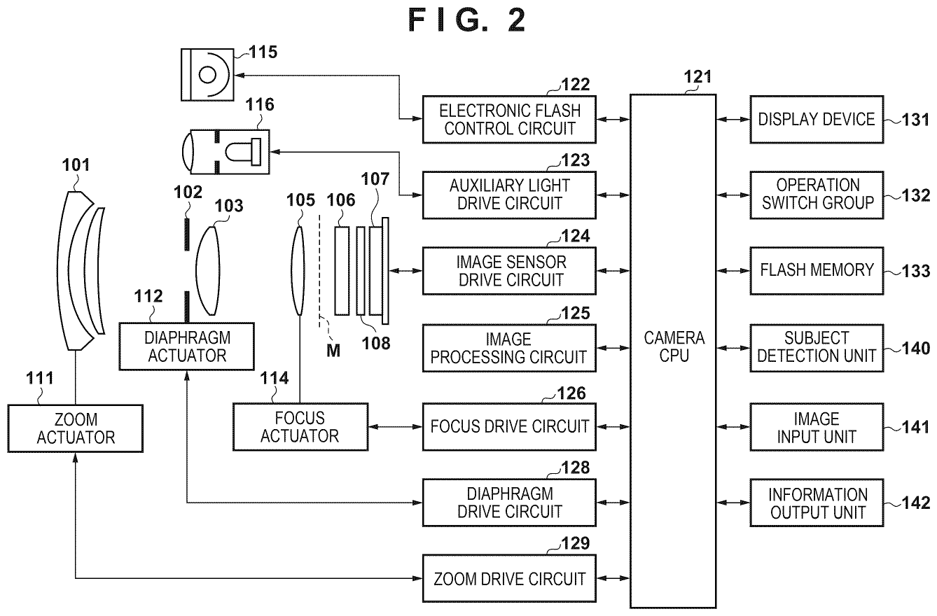

FIG. 2 is a diagram illustrating the configuration of the camera 100 functioning as an image capture apparatus according to the first embodiment of the present disclosure. In FIG. 2, a first lens group 101 is disposed further to the subject side (front side) of the imaging optical system as a focusing optical system and is held in a manner allowing for movement in the optical axis direction. A diaphragm 102 performs light amount adjustment via adjustment of the opening diameter. A second lens group 103 moves integrally with the diaphragm 102 in the optical axis direction to change the magnification (zoom in and out) together with the first lens group 101 moving in the optical axis direction.

A third lens group (focus lens) 105 performs focus adjustment via movement in the optical axis direction. An optical low-pass filter 108 is an optical element for reducing false color and moire in the captured image. The first lens group 101, the diaphragm 102, the second lens group 103, the third lens group 105, and the optical low-pass filter 108 form the imaging optical system.

A zoom actuator 111 turns a cam barrel (not illustrated) about the optical axis to move the first lens group 101 and the second lens group 103 in the optical axis direction via a cam provided in the cam barrel to change the magnification. A diaphragm actuator 112 drives a plurality of light-shielding blades (not illustrated) in the open and close direction for a light amount adjustment operation of the diaphragm 102. A focus actuator 114 moves the third lens group 105 in the optical axis direction to perform focus adjustment.

A focus drive circuit 126 drives the focus actuator 114 in response to a focus drive command from a camera CPU 121 to move the third lens group 105 in the optical axis direction. A diaphragm drive circuit 128 drives the diaphragm actuator 112 in response to a diaphragm drive command from the camera CPU 121. A zoom drive circuit 129 drives the zoom actuator 111 in accordance with a zoom operation performed by the user.

Note that in the present embodiment, the interchangeable lens including the imaging optical system, the actuators 111, 112, and 114, and the drive circuits 126, 128, and 129 can be attached to and detached from the camera body using a mount portion M that can connect electrically or mechanically. However, the imaging optical system, the actuators 111, 112, and 114, and the drive circuits 126, 128, and 129 may be integrally formed with the camera body including an image sensor 107.

An electronic flash 115 includes light-emitting elements such as xenon tubes or LEDs and emits light for illuminating the subject. An AF auxiliary light emitting unit 116 includes light-emitting elements such as LEDs and improves the focus detection performance with respect to a subject in dark or low contrast by projecting an image of a mask including a predetermined aperture pattern on the subject via a light projection lens. An electronic flash control circuit 122 performs control to turn on the electronic flash 115 in synchronization with the image capture operation. An auxiliary light drive circuit 123 performs control to turn on the AF auxiliary light emitting unit 116 in synchronization with the focus detection operation.

The camera CPU 121 performs various types of control for the camera 100. The camera CPU 121 includes a computation unit, a ROM, a RAM, an A/D converter, a D/A converter, a communication interface circuit, and the like. The camera CPU 121 drives various types of circuits in the camera 100 and controls a series of operations for AF, image capturing, image processing, recording, and the like in accordance with computer programs stored in the ROM. The camera CPU 121 functions as an image processing apparatus.

The image sensor 107 is formed of a two-dimensional CMOS photo sensor including a plurality of pixels and a peripheral circuit thereof and disposed on an image forming surface of the imaging optical system. The image sensor 107 performs photoelectric conversion of the subject image formed by the imaging optical system. An image sensor drive circuit 124 controls the operation of the image sensor 107 and A/D converts an analog signal generated via photoelectric conversion and transmits the digital signal to the camera CPU 121.

A shutter 106 includes a focal plane shutter configuration and is driven by a shutter drive circuit built into the shutter 106 based on instructions from the camera CPU 121. The shutter 106 shields the image sensor 107 from light while reading a signal of the image sensor 107. Also, the shutter 106 keeps the focal plane shutter open during exposure and guides the imaging light beam to the image sensor 107.

An image processing circuit 125 applies predetermined image processing on image data stored in the RAM installed in the camera CPU 121. The image processing to be applied by the image processing circuit 125 includes but is not limited to so-called development processing such as white balance adjustment, color interpolation (demosaicing), and gamma correction, as well as signal format conversion processing, scaling processing, and the like. Furthermore, the image processing circuit 125 determines a main subject based on posture information of the subject and position information of an object specific to a scene (hereinafter referred to as specific object). The result of the determination processing may be used in other image processing (for example, white balance adjustment processing). The image processing circuit 125 stores, in the RAM in the camera CPU 121, processed image data, joint position information for each subject, position and size information of the specific object, centroid information of a subject determined to be the main subject, position information of faces and pupils, and the like.

A display device (display unit) 131 includes display elements such as LCDs and displays information relating to the image capture mode of the camera 100, a pre-image-capture preview image, a post-image-capture image for confirmation, a marker and focus image of a focus detection area, and the like. An operation switch group 132 includes a main (power supply) switch, a release (image capture trigger) switch, a zoom operation switch, an image capture mode selection switch, and the like and is operated by the user. A flash memory 133 records the captured images. The flash memory 133 can be attached to and detached from the camera 100.

A subject detection unit 140 functioning as a subject detecting unit performs subject detection based on dictionary data generated by machine learning. In the present embodiment, to detect a plurality of types of subjects, the subject detection unit 140 uses dictionary data for each subject. Each set of dictionary data is data in which corresponding subject features are registered, for example. The subject detection unit 140 performs subject detection while sequentially switching between the dictionary data for each subject. The dictionary data for each subject is stored in a dictionary data storage unit (the ROM in the camera CPU 121). Accordingly, the dictionary data storage unit stores a plurality of sets of dictionary data. The camera CPU 121 determines which dictionary data to use, from among the plurality of sets of dictionary data, to perform subject detection based on a preset subject priority and the settings of the image capture apparatus.

An image input unit 141 is input when the images generated when shooting (image generation) is performed in the virtual space, and the camera CPU 121 executes processing of displaying the input images on the display device 131 and storing them in the flash memory 133. An information output unit 142 outputs various types of information to the external computation apparatus 1000 when shooting is performed in the virtual space. The camera operation information, as information to be output, includes a release operation, a lens zooming and focusing operation, and the like for image capture instructions. Also, camera settings information, as information to be output, includes settings information relating to the mode when performing continuous shooting, autofocus, photometry, exposure condition settings, image generation, lens control, and the like. Also, camera control information, as information to be output, includes information relating to correction values, thresholds, and the like used in various types of algorithms used in shooting and image generation. Also, information indicating the camera position and shooting direction is output. The details will be described below.

Examples of the dictionary data for subject detection include dictionary data for detecting “people” as the subject, dictionary data for detecting “animals” as the subject, dictionary data for detecting “vehicles”, and the like. Also, the dictionary data for detecting “whole people” and the dictionary data for detecting “faces of people” may be stored separately in the dictionary data storage unit.

In the present embodiment, the subject detection unit 140 is constituted by a machine-learning-trained convolutional neural network (CNN) and estimates the position of a subject included in image data and the like. The subject detection unit 140 may be implemented by a circuit specialized in estimation processing with a graphics processing unit (GPU) or a CNN.

The machine learning of the CNN may be performed by any method. For example, a predetermined computer such as a server or the like may perform the machine learning for the CNN, and the camera 100 may obtain the trained CNN from the predetermined computer. For example, the predetermined computer may perform training of the CNN of the subject detection unit 140 by performing supervised learning using image data for training as an input and the positions of subjects corresponding to the image data for training as the teacher data. In this manner, a trained CNN is created. The training of the CNN may be performed in the camera 100 or the image processing apparatus described above.

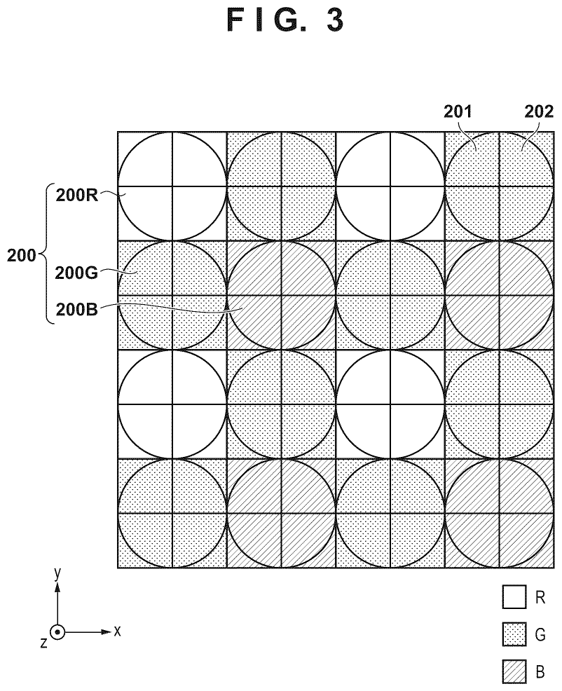

Next, the image array of the image sensor 107 will be described using FIG. 3. FIG. 3 illustrates a pixel array of an area of 4 pixel columns by 4 pixel rows of the image sensor 107 as seen from the optical axis direction (z direction).

One pixel unit 200 includes four imaging pixels arranged in a 2 by 2 grid. By arranging a plurality of the pixel units 200 on the image sensor 107, photoelectric conversion of a two-dimensional subject image can be performed. In one pixel unit 200, an imaging pixel (hereinafter referred to as R pixel) 200R having red (R) spectral sensitivity is arranged in the upper left, and an imaging pixel (hereinafter referred to as G pixel) 200G having green (G) spectral sensitivity is arranged in the upper right and the lower left. Also, an imaging pixel (hereinafter referred to as B pixel) 200B having blue (B) spectral sensitivity is arranged in the lower right. Also, each imaging pixel includes a first focus detecting pixel 201 and a second focus detecting pixel 202 divided in the horizontal direction (x direction).

In the image sensor 107 according to the present embodiment, a pixel pitch P of the imaging pixels is 4 μm, and an imaging pixel number N is horizontal (x) 5575 columns by vertical (y) 3725 rows equaling approximately 20750000 pixels. Also, a pixel pitch PAF of the focus detecting pixels is 2 μm, and a focus detecting pixel number NAF is horizontal 11150 columns by vertical 3725 rows equaling approximately 41500000 pixels.

In the present embodiment, a case in which each imaging pixel is divided in two in the horizontal direction is described. However, each imaging pixel may be divided in the vertical direction. Also, the image sensor 107 according to the present embodiment includes a plurality of imaging pixels including the first and second focus detecting pixels. However, the imaging pixels and the first and second focus detecting pixels may be provided as separate pixels. For example, among the plurality of imaging pixels, the first and second focus detecting pixels may be discretely arranged.

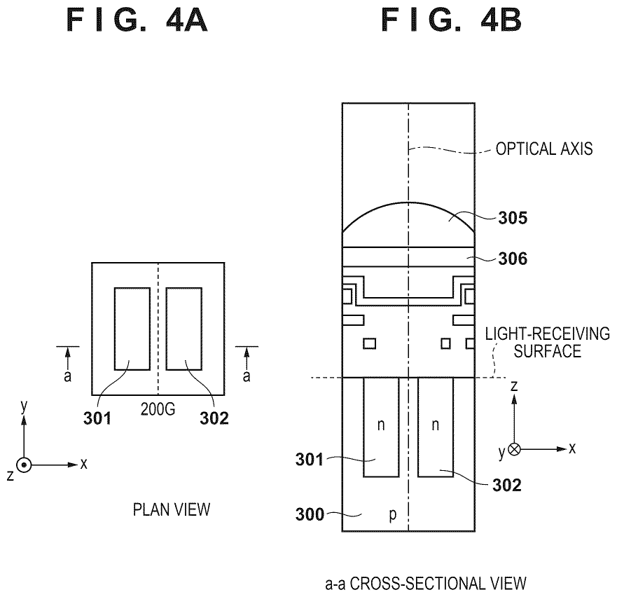

FIG. 4A illustrates one imaging pixel (200R, 200G, 200B) as seen from the light-receiving surface side (+z direction) of the image sensor 107. FIG. 4B illustrates cross section a-a of the imaging pixel of FIG. 4A as seen from the −y direction. As illustrated in FIG. 4B, one imaging pixel is provided with one micro lens 305 for gathering incident light.

Also, the imaging pixel is provided with photoelectric conversion units 301 and 302 obtained by dividing the imaging pixel in N (dividing in 2 in the present embodiment) in the x-direction. The photoelectric conversion units 301 and 302 correspond to the first focus detecting pixel 201 and the second focus detecting pixel 202, respectively. The centroids of the photoelectric conversion units 301 and 302 are eccentric to the −x side and the +x side with respect to the optical axis of the micro lens 305.

An R, G, or B color filter 306 is provided between the micro lens 305 and the photoelectric conversion units 301 and 302 in each imaging pixel. Note that the spectral transmittance of the color filter may be changed for each photoelectric conversion unit, or the color filter may be omitted.

Light incident on the imaging pixel from the imaging optical system is gathered by the micro lens 305 and spectrally separated at the color filter 306. This is then received at the photoelectric conversion units 301 and 302, where it undergoes photoelectric conversion. The camera 100 including the image sensor 107 illustrated in FIGS. 3, 4A, and 4B can perform phase difference focus detection, that is, detection of a phase difference between a pair of signal rows obtained by separating a light beam passing through the imaging optical system via known technology (for example, Japanese Patent Laid-Open No. 2023-95509). By phase difference focus detection, the defocus amount of a predetermined area within the range to be captured can be detected along with the direction. The details will not be described.

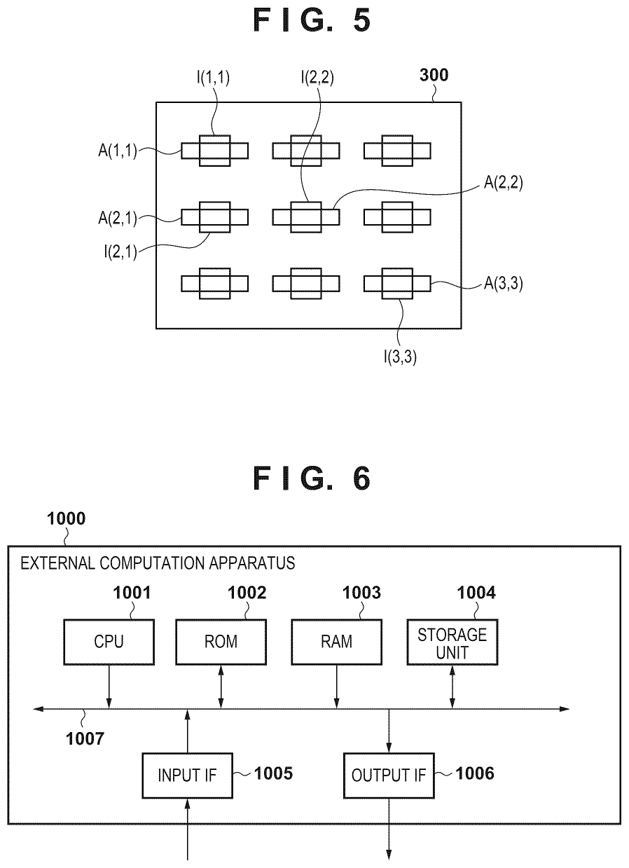

Next, the focus detection area, which is an area of the image sensor 107 for obtaining a pair of signal rows for detecting a phase difference, will be described using FIG. 5. In FIG. 5, A(n,m) indicates a focus detection area at the n-th in the x-direction and the m-th in the y-direction of the plurality (three in the x-direction and three in the y-direction totaling nine) of focus detection areas set in an effective pixel area 300 of the image sensor 107. The pair of signal rows are produced from the plurality of pixels included in the focus detection area A(n,m). I(n,m) indicates a marker displaying the position of the focus detection area A(n,m) in the display device 131.

Note that the nine focus detection areas illustrated in FIG. 5 are merely examples, and the number, position, and size of the focus detection areas are not limited. For example, in a predetermined area centered on a position designated by the user or a subject position detected by a subject detector, one or more areas may be set as the focus detection area. In the present embodiment, when obtaining a defocus map as described below, the focus detection area is arranged so that the focus detection result is obtained with a higher resolution. For example, on the image sensor, a total of 9600 focus detection areas, divided into 120 horizontally and 80 vertically, may be arranged.

FIG. 6 is a block diagram illustrating an example of the hardware configuration of the external computation apparatus 1000. The external computation apparatus 1000 includes a CPU 1001, a RAM 1003, a ROM 1002, a storage unit 1004, an input interface 1005, an output interface 1006, and a system bus 1007. The camera 100, the camera/lens information storage apparatus 2000, and the like are connected to the input interface 1005. The camera 100 is connected to the output interface 1006.

The CPU 1001 is a processor that comprehensively controls the component elements of the external computation apparatus 1000. The RAM 1003 is a memory that functions as a main memory of the CPU 1001 and a working area. The ROM 1002 is a memory that stores programs and the like used in processing in the external computation apparatus 1000. The CPU 1001 uses the RAM 1003 as a working area and executes a program stored in the ROM 1002 to execute the various types of processing described below.

The storage unit 1004 is a storage device that stores image data used in the processing in the external computation apparatus 1000, parameters (in other words, setting values) for the processing, and the like. A HDD, optical disk drive, flash memory, or the like may be used as the storage unit 1004.

The input interface 1005 is a serial bus interface such as USB, IEEE 1394, or the like, for example. The external computation apparatus 1000 can obtain the various types of information described above from the camera 100 via the input interface 1005. The output interface 1006 is an image output terminal such as DVI, HDMI (registered trademark), or the like, for example. The external computation apparatus 1000 can output image data processed in the external computation apparatus 1000 to the display device 131 of the camera 100 via the output interface 1006. Image for recording on the flash memory 133 of the camera 100 can also be output. Note that the external computation apparatus 1000 may include component elements other than those described above, but as these are not the focus of the present disclosure, they will not be described.

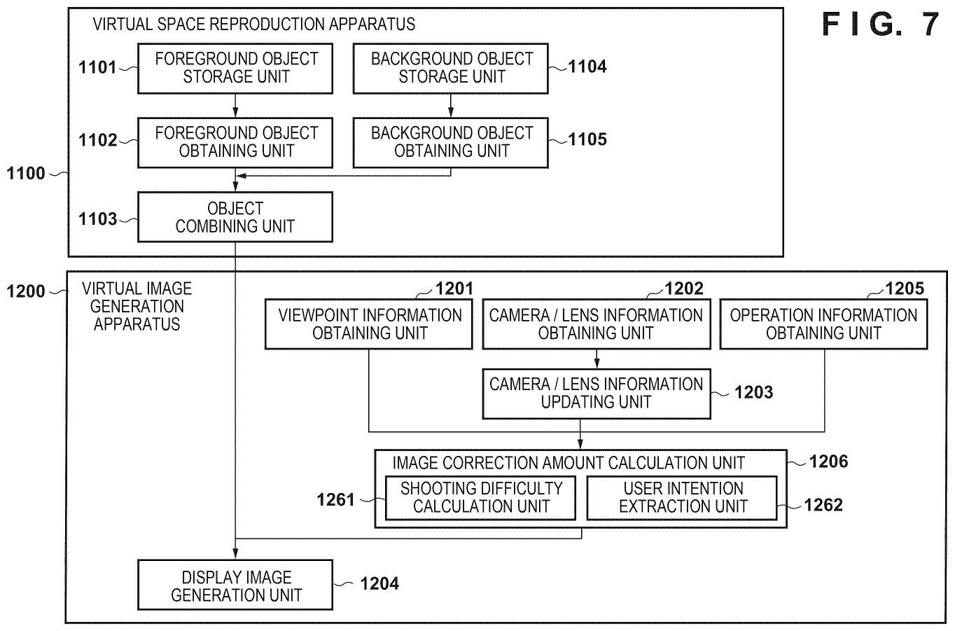

Next, the generation processing for virtual images executed in the external computation apparatus 1000 using the hardware configuration of FIG. 6 will be described using FIG. 7. FIG. 7 is a block diagram illustrating the functional configuration of the external computation apparatus 1000. In the present embodiment, the CPU 1001 implements the blocks described using FIG. 7 by executing programs stored in the ROM 1002. However, the CPU 1001 does not need to execute all of the functions, and processing circuitry that executes the function may be provided in each unit of the external computation apparatus 1000.

First, the virtual space reproduction apparatus 1100 will be described. A three-dimensional object of a person such as a stage performer, which is a foreground subject stored in a foreground object storage unit 1101, is obtained by a foreground object obtaining unit 1102. The three-dimensional object is three-dimensional shape data describing information indicating shape and color and is constituted by a textured mesh model, three-dimensional points colored at each points, and the like. Note that the three-dimensional object may not be colored. The object stored in the foreground object storage unit 1101 may conceivably be various three-dimensional objects such as people of different race, gender, and age, various types of animals, moving bodies such as vehicles, and the like. The foreground object obtained by the foreground object obtaining unit 1102 is not limited to one object, and a plurality may be obtained. The three-dimensional object also includes, as subject information, information of the speed, acceleration, angular velocity, angular acceleration, size, and contrast. Also, in advance, a three-dimensional object may be generated from a captured image of the subject the user wishes to shoot in the virtual space using a trained model for estimating the three-dimensional model of an image, with the size and contrast information also being able to be stored. Also, by using a plurality of time series images, information of the speed, acceleration, angular velocity, and angular acceleration of the three-dimensional object may also be able to be generated and stored.

In another method, a three-dimensional object may be generated from captured images captured using a plurality of image capture apparatuses at different viewpoints and stored. The imaging area is captured from a plurality of directions by the plurality of image capture apparatuses. The imaging area is an indoor photo studio, a stage where plays are performed, or the like. The plurality of image capture apparatuses are disposed at different positions surrounding the imaging area and captures images in synchronization. Note that the plurality of image capture apparatuses may be placed around the entire circumference of the imaging area or may be placed only in one or more directions of the imaging area due to placement constraints. Also, the number of image capture apparatuses can be set according to various methods. For example, in a case where the imaging area is a soccer stadium, approximately 30 image capture apparatuses may be placed around the stadium. Also, image capture apparatuses with different functions, such as a telephoto camera or a wide-angle camera, may be placed.

Regarding each of the plurality of image capture apparatuses, a parameter set including a parameter representing the three-dimensional position, a parameter representing the direction of the image capture apparatus in terms of the pan, tilt, and roll directions, the size (angle of view) of the field of view of the image capture apparatus, and the resolution may be described for each image capture apparatus. The information included in the parameter set is calculated in advance via a known camera calibration process and stored in an appropriate storage apparatus (for example, the foreground object storage unit 1101). In other words, the association of points in a plurality of images based on the image capturing of a plurality of image capture apparatuses is calculated via geometric calculation. Note that the content of the information included in the parameter set is not limited to that described above. For example, the information may include a plurality of parameter sets corresponding to a plurality of frames constituting a video from an image capture apparatus and may indicate the position and direction of the image capture apparatus at consecutive points in time.

The foreground object obtaining unit 1102 generates a three-dimensional object of a person, such as a stage performer, as a foreground subject in accordance with the method described in Japanese Patent Laid-Open No. 2017-211827, for example, based on images at a plurality of viewpoints received from the image capture apparatuses and the parameter sets.

In a similar manner, a background object obtaining unit 1105 obtains a three-dimensional object, such as a stage or stadium acting as the background stored in a background object storage unit 1104, as a space for placing the foreground object in. Conceivable examples of a background object stored in the background object storage unit 1104 include a three-dimensional object of various spaces such as a large concert hall, a soccer stadium, and a small indoor room. CAD or similar design data may be used in the background object, and shapes scanned with a laser scanner or the like and color data may be used in the background object. Alternatively, Structure from Motion or similar computer vision technology may be used to generate the background object from image groups from a plurality of viewpoints.
An object combining unit 1103 places the foreground object in the space of the obtained background object. The information relating to the foreground object obtained by the object combining unit 1103 can include a three-dimensional model of the subject at a plurality of moments in time corresponding to the shape and color of the subject at the plurality of moments in time. At the time of placement, the foreground object is placed so that it does not float above the ground included in the background object, unless there is interference between objects or an action such as jumping. The foreground object may be placed in accordance with object placement information (position, orientation) held by the background object or may be placed based on instructions from the outside such as from the user.
Next, the virtual image generation apparatus 1200 will be described.

A viewpoint information obtaining unit 1201 obtains a virtual viewpoint parameter including the position of the virtual viewpoint in the virtual space and the direction (pan, tilt, roll). The virtual viewpoint parameter may be set to an initial value, a registered value, a previous history position, or the like in the virtual space or may be set by user instruction.

A camera/lens information obtaining unit 1202 obtains information relating to the camera and lens used in virtual space shooting from a camera/lens information storage apparatus 2000 or the camera 100. The details of the information will be described below. A camera/lens information updating unit 1203 obtains the camera/lens information each time it is updated along with the passage of time and updates the camera/lens information.

An operation information obtaining unit 1205 obtains camera and lens operation information from the camera 100. The details of the information will be described below.

The viewpoint information, the camera/lens information, and the operation information are input into an image correction amount calculation unit 1206, and the image correction amount calculation unit 1206 calculates the image correction amount. The image correction amount calculation unit 1206 calculates the image correction amount using the information obtained from a shooting difficulty calculation unit 1261 and a user intention extraction unit 1262. The details of the processing will be described below.

A display image generation unit 1204 uses the foreground obtained from the object combining unit 1103, the background object information, the virtual viewpoint information, and the camera/lens information to perform rendering and generate a virtual image. The generated virtual image is output to the camera 100 and displayed on the display device 131 of the camera 100. The generated virtual image is also recorded in the flash memory 133 of the camera 100 or the storage unit 1004 of the external computation apparatus 1000.

### Image Capture Processing

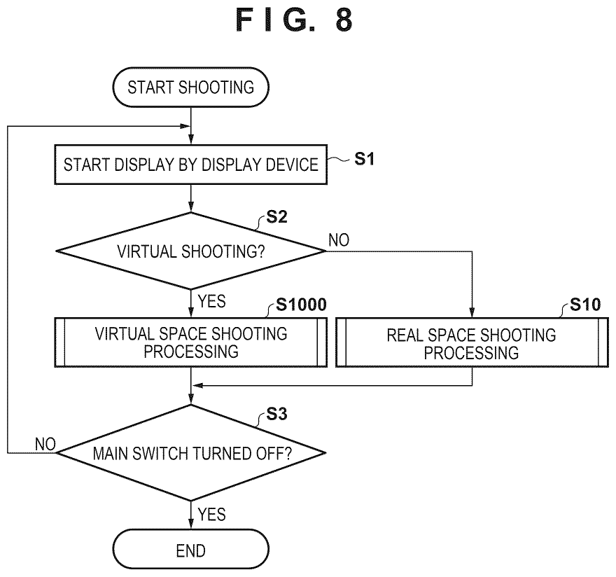

The flowchart of FIG. 8 illustrates the processing for causing the camera 100 according to the present embodiment to perform real space shooting and virtual space shooting. Specifically, the flowchart illustrates the processing from an operation before image capture of displaying an image on the display device 131 of the camera 100 to when still image capture is performed. The camera CPU 121, a computer, executes the present processing according to a computer program. Hereinafter, “S”denotes the term “step”.

First, in S1, the camera CPU 121 causes the display device 131 to start displaying a menu for settings, display a live view image of the real space or the virtual space, and the like. The generation of the live view image to reproduce will be described below. Via initial activation or a user operation, a menu settings screen is displayed on the display device 131 for the user to select whether to shoot in the real space or shoot in the virtual space. The display content may be determined based on the history from the time of a previous activation. In a case where shooting in the real space or the virtual space has already been set, a live view display started in advance is continued.

In S2, the camera CPU 121 determines whether or not to perform virtual space shooting based on a user instruction or the previous history. In the case of “Yes” in S2, the processing proceeds to S1000, and virtual space shooting processing is executed. In the case of “No” in S2, the processing proceeds to S10, and real space shooting processing is executed. When the processing of S10 or S1000 ends, the processing proceeds to S3.

In S3, the camera CPU 121 determines whether a main switch included in the operation switch group 132 has been turned off. In a case where the main switch has been turned off, the camera CPU 121 ends the present processing. In a case where the main switch has not been turned off, the processing returns to S1.

### Real Space Shooting Processing

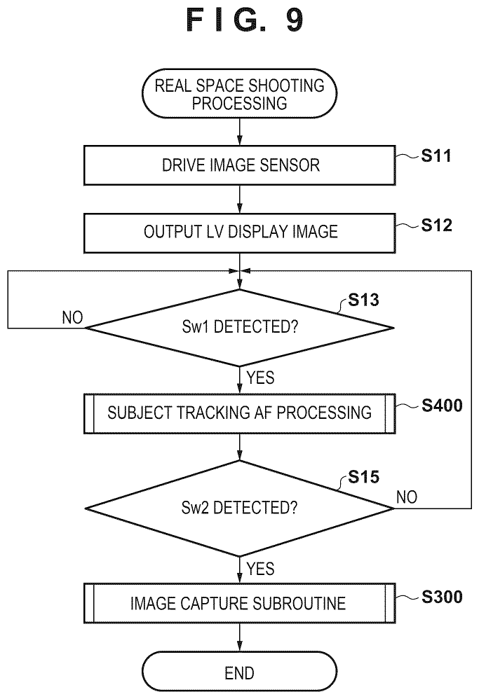

The flowchart of FIG. 9 illustrates the real space shooting processing illustrated in S10 of FIG. 8. Specifically, the flowchart illustrates the processing of operations from an operation before image capture of displaying a live view image on the display device 131 of the camera 100 to when still image capture is performed. The camera CPU 121, a computer, executes the present processing according to a computer program. Hereinafter, “S”denotes the term “step”.

First, in S11, the camera CPU 121 causes the image sensor drive circuit 124 to drive the image sensor 107 and obtains captured image data from the image sensor 107. Thereafter, the camera CPU 121, from the obtained captured image data, obtains a pair of focus detection signals from the pair of focus detecting pixels included in the focus detection areas illustrated in FIG. 5. Also, the camera CPU 121 generates an imaging signal by adding together the pair of focus detection signals of all of the effective pixels of the image sensor 107 and causes the image processing circuit 125 to execute image processing on the imaging signal (captured image data) to obtain image data. Note that in a case where the imaging pixels and the focus detecting pixels are separately provided, the camera CPU 121 obtains the image data by executing complementing processing on the pixels for focus detection.

In S12, the camera CPU 121 causes the image processing circuit 125 to generate a live view image from the image data obtained in S11 and displays this on the display device 131. Note that the live view image is a scaled down image matching the resolution of the display device 131, and the user can adjust the imaging composition, exposure conditions, and the like while viewing the live view image. Accordingly, the camera CPU 121 performs exposure adjustment based on the photometric values obtained from the image data and displays the live view image on the display device 131. The exposure adjustment is implemented via exposure time, opening/closing the diaphragm opening of the imaging lens, and appropriately performing gain adjustment on the image sensor output.

Next, in S13, the camera CPU 121 determines whether or not a switch Sw1 for instructing to start image capture preparations has been turned on via a half-press operation of the release switch included in the operation switch group 132. In a case where the switch Sw1 has not been turned on, the camera CPU 121 repeats the determination of S13 to monitor the timing of when the switch Sw1 will be turned on. In a case where the switch Sw1 has been turned on, the camera CPU 121 advances the processing to S400 and executes subject tracking autofocus (AF) processing. Here, based on the obtained imaging signals, detecting of a subject area from the focus detection signals, setting of the focus detection area, a predictive AF processing for suppressing the influence of a time lag until focus detection processing and image capture processing for a recorded image, and the like are executed. The details will be described below.

In S15, the camera CPU 121 determines whether or not a switch Sw2 for instructing to start image capture operations has been turned on via a full-press operation of the release switch. In a case where the switch Sw2 has not been turned on, the camera CPU 121 returns the processing to S13. In a case where the switch Sw2 has been turned on, the processing proceeds to S300, and an image capture subroutine is executed. The details of the image capture subroutine will be described below. When the image capture subroutine ends, the present processing ends.

In the present embodiment, after on is detected for the switch Sw1 in S3, subject detection processing and AF processing is executed. However, the timing of these processing is not limited thereto. In a state prior to the switch Sw1 being turned on, the subject tracking AF processing executed in S400 may be executed to make the preliminary operations before shooting by the user unnecessary.

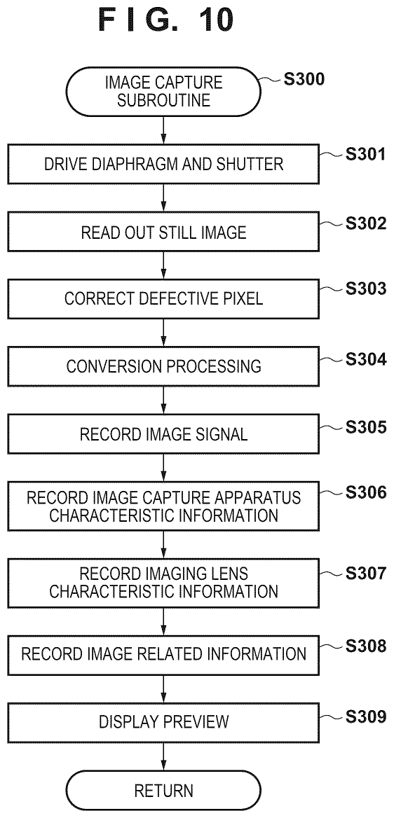

Next, the image capture subroutine executed by the camera CPU 121 in S300 of FIG. 9 will be described using the flowchart illustrated in FIG. 10.

In S301, the camera CPU 121 executes exposure control processing and determines the image capture conditions (shutter speed, f-number, image capture sensitivity, and the like). The exposure control processing can be executed using brightness information obtained from the image data of the live view image.

Then, the camera CPU 121 transmits the determined f-number to the diaphragm drive circuit 128 and causes it to drive the diaphragm 102. Also, the camera CPU 121 transmits the determined shutter speed to the shutter 106 and performs an operation to open the focal plane shutter. Furthermore, the camera CPU 121 causes the image sensor 107 to accumulate charge during an exposure period via the image sensor drive circuit 124.

In S302, the camera CPU 121, having executed the exposure control processing, causes the image sensor drive circuit 124 to perform a full-pixel readout of the imaging signals from still image capture from the image sensor 107. Also, the camera CPU 121 causes the image sensor drive circuit 124 to perform a readout of one of the pairs of focus detection signals from the focus detection area (focus target area) in the image sensor 107. The focus detection signals read out at this time are used to detect the focus state of the image during image reproduction described below. By subtracting one focus detection signal of the pair of focus detection signals from the imaging signal, it is possible to obtain the other focus detection signal.

In S303, the camera CPU 121 causes the image processing circuit 125 to execute defective pixel correction processing with respect to the captured image data obtained by being read out in S302 and A/D converted.

In S304, the camera CPU 121 causes the image processing circuit 125 to execute image processing such as demosaic (color interpolation) processing, white balance processing, gamma correction (tone correction) processing, color conversion processing, and edge enhancement processing and coding processing with respect to the captured image data after the defective pixel correction processing.

In S305, the camera CPU 121 records still image data as image data, which is obtained by performing the image processing and the coding processing in S304, and one focus detection signal, which is read out in S302, in the memory 133 as an image data file.

In S306, the camera CPU 121 records camera characteristic information, as characteristic information of the camera 100 in association with the still image data recorded in S305 in the memory 133 and the memory inside the camera CPU 121. The camera characteristic information includes the following information, for example.
Image capture conditions (f-number, shutter speed, image capture sensitivity, and the like)
Information relating to image processing executed by the image processing circuit 125
Information relating to the light receiving sensitivity distribution of the imaging pixels and the focus detecting pixels of the image sensor 107
Information relating to vignetting of the image capture light flux in the camera 100
Information of the distance from the mounting surface of the imaging optical system on the camera 100 to the image sensor 107
Information relating to manufacturing errors of the camera 100
   The information relating to the light receiving sensitivity distribution of the imaging pixels and the focus detecting pixels (hereinafter referred to simply as light receiving sensitivity distribution information) is information of the sensitivity of the image sensor 107 according to the distance (position) from the optical axis. The light receiving sensitivity distribution information is dependent on the micro lens 305 and the photoelectric conversion units 301 and 302 and thus may be information relating to these. Also, the light receiving sensitivity distribution information may be information of the change in sensitivity with respect to the angle of incidence of the light.

In S307, the camera CPU 121 records lens characteristic information, as characteristic information of the imaging optical system in association with the still image data recorded in S305 in the memory 133 and the memory inside the camera CPU 121. The lens characteristic information includes, for example, information relating to the exit pupil, information relating to a frame such as a lens barrel that turns down the light flux, information of the focal length and f-number at the time of image capture, information relating to aberration of the imaging optical system, information relating to manufacturing errors of the imaging optical system, and information of the position (subject distance) of the focus lens 105 at the time of image capture.

In S308, the camera CPU 121 records the image related information as information relating to the still image data in the memory 133 and the memory in the camera CPU 121. The image related information includes, for example, information relating to the focus detection operation before image capture, information relating to the movement of the subject, and information relating to focus detection accuracy.

In S309, the camera CPU 121 causes the display device 131 to perform a preview display of the captured image. This allows the user to easily confirm the captured image.

When the processing of S309 ends, the camera CPU 121 ends the present image capture subroutine.

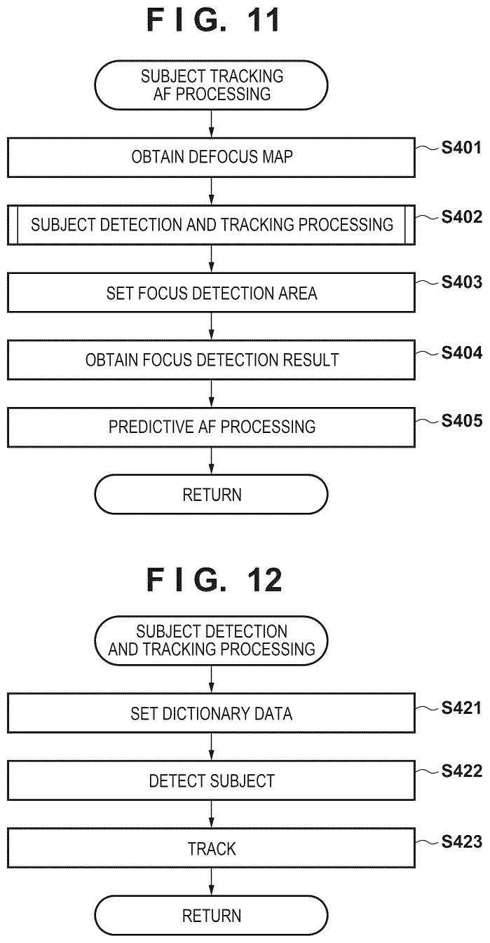

Next, the subject tracking AF processing subroutine executed by the camera CPU 121 in S400 of FIG. 9 will be described using the flowchart illustrated in FIG. 11.

In S401, the camera CPU 121 calculates the image misalignment amount between the pair of focus detection signals obtained in each of the plurality of focus detection areas obtained in S11, calculates the defocus amount for each focus detection area from the image misalignment amount, and obtains a defocus map. As described above, in the present embodiment, a group of focus detection results obtained from the focus detection areas totaling 9600 due to the 120 horizontal divisions and 80 vertical divisions on the image sensor is referred to as the defocus map.

In S402, the camera CPU 121 executes subject detection and tracking processing. The subject detection processing is executed by the subject detection unit 140 described above. In subject detection, there are cases where detection is impossible due to the state of the obtained image. In such cases, tracking processing using other methods such as template matching is executed, and the position of the subject is estimated. The details will be described below.

In S403, the camera CPU 121 functioning as a local area selecting unit uses the information of the subject detection area obtained in S402 and performs setting of the focus detection area. The camera CPU 121 obtains information such as the position and size of the subject, reliability, and the like as the information of the subject detection area obtained as the output of the subject detection and tracking processing executed in S402. Setting the focus detection area may include, from the result of the focus detection area in the area set as the subject detection area, selecting a focus detection result that indicates the subject with high reliability and at a distance that is relatively on the closer side. Also, for setting the focus detection area, the focus detection area may be arranged again in a region set as the obtained subject detection area, the image data and focus detection signals may be again obtained, and selection of the focus detection result may be performed in a similar manner.

In S404, the camera CPU 121 obtains the focus detection result of the set focus detection area. The focus detection result obtained here may be the focus detection result closest to the desired area selected from among the focus detection results calculated in S401 or may be the defocus amount newly calculated using the focus detection signals corresponding to the set focus detection area. Also, the focus detection area for calculating the defocus amount is not limited to one and may be a plurality of focus detection areas arranged around for calculating the defocus amount.

In S405, the camera CPU 121 performs predictive AF processing using the defocus amount obtained in S404 and the plurality of defocus amounts which are time series data of the timing of when previous focus detections were performed. This is required processing in a case where there is a time lag between the timing when focus detection was performed and the timing of performing exposure of the captured image. The position of the subject in the optical axis direction at the timing of when exposure of the captured image is performed, that is, a predetermined time with respect to the timing of when focus detection was performed, is predicted, and AF control is performed. In predicting the image plane position of the subject, Multivariate analysis (for example, the least squares method) is performed using the history of previous subject image plane positions and time to obtain a predictive curve formula. By substituting the time of the timing when exposure of the captured image is performed into the obtained predictive curve formula, an image plane predictive position wp of the subject can be calculated.

Also, the three-dimensional position may also be predicted along with the position in the optical axis direction. For example, take a case of a vector in the XYZ direction, with the screen top being the XY direction and the optical axis direction being the Z direction. In this case, the position of the subject at the timing of when exposure of the captured image is performed may be predicted from the XY position of the subject obtained in the subject detection and tracking processing of S402 and time series data of the position in the Z direction based on the defocus amount obtained in S405. Also, the subject position may be predicted from the time series data of the joint position of the person who is the subject.

Via the prediction described above, even in a case where a ball or person is temporarily hidden or a portion of the joint position of a person is temporarily hidden, each position can be estimated via prediction. The subject to be predicted is not only a main subject, and prediction is performed on a plurality of detected subjects. By executing predictive AF processing on a plurality of subjects, when the main subject is switched, history of the defocus amount of the new main subject does not need to be newly accumulated. Thus, predictive AF processing can be continued without a loss of time.

In S405, using the predictive AF processing, the drive amount of the focus lens is calculated, the focus actuator 114 is driven in response to a focus drive command from the camera CPU 121, and the third lens group 105 is moved in the optical axis direction to execute focus adjustment processing.

When the processing of S405 ends, the camera CPU 121 ends the present subject tracking AF processing subroutine and advances the processing to S15 of FIG. 9.

Next, the subject detection and tracking processing subroutine executed by the camera CPU 121 in S402 of FIG. 11 will be described using the flowchart illustrated in FIG. 12.

In S421, the camera CPU 121 performs setting of the dictionary data according to the type of subject to be detected based on the data detected from the image data obtained in S12 of FIG. 9. The dictionary data to use in the present processing is selected from a plurality of pieces of dictionary data stored in the dictionary data storage unit based on the preset subject priority and settings of the image capture apparatus. For example, as the plurality of pieces of dictionary data, dictionary data classified by subject, such as “person”, “vehicle”, “animal”, and the like is stored. In the present embodiment, one piece of dictionary data may be selected or a plurality may be selected. In the case of one, detection of the subject that can be detected by the one piece of dictionary data can be repeated at a high frequency. On the other hand, in the case of a plurality of pieces of dictionary data, the dictionary data is sequentially set according to the priority of the detection subject allowing for subjects to be sequentially detected.

In S422, the subject detection unit 140 performs subject detection using the dictionary data set in S421, with the image data read out in S12 of FIG. 9 as the input image. At this time, the subject detection unit 140 outputs information such as the position and size of the subject to be detected, the reliability, and the like. At this time, the camera CPU 121 may cause the display device 131 to display the information described above output by the subject detection unit 140.

In S422, a plurality of areas of the subject are detected hierarchically from the image data. For example, in a case where “person” or “animal” is set as the dictionary data, a “whole body” area and a plurality of organs such as a “face” area, and an “eye” area are detected. A localized area such as the eye or face of a person may be unable to be detected due to an obstacle in the surroundings or the orientation of the face, even if the area, as a subject, is to be focused on or matched in terms of the exposure state. In such a case, by detecting the whole body, robust detection of the subject is continued, and the subject is detected hierarchically. In a similar manner, in a case where a “vehicle” such as a bike is set as the dictionary data, a whole body including a driver and vehicle body and a localized area such as a helmet (head portion) are hierarchically detected.

In S423, the camera CPU 121 executes known template matching processing with the subject detection area obtained in S422 as the template. Using the plurality of images obtained in S12 and using the subject detection area obtained from a previous image as a template, a similar area is searched for in the image most recently obtained. As the information to use in template matching, as is known, brightness information; color histogram information; corner, edge, or similar feature point information; or the like may be used. Various methods are conceivable for the matching method and the template updating method, and any of these methods may be used. In a case where a subject is not detected in S422, by detecting an area similar to previous subject detection data from the image data most recently obtained, the tracking processing executed in S423 is executed for implementing stable subject detection and tracking processing.

When the processing of S423 ends, the camera CPU 121 ends the subject detection and tracking processing subroutine and proceeds to S403 of FIG. 11.

### Virtual Space Shooting Processing

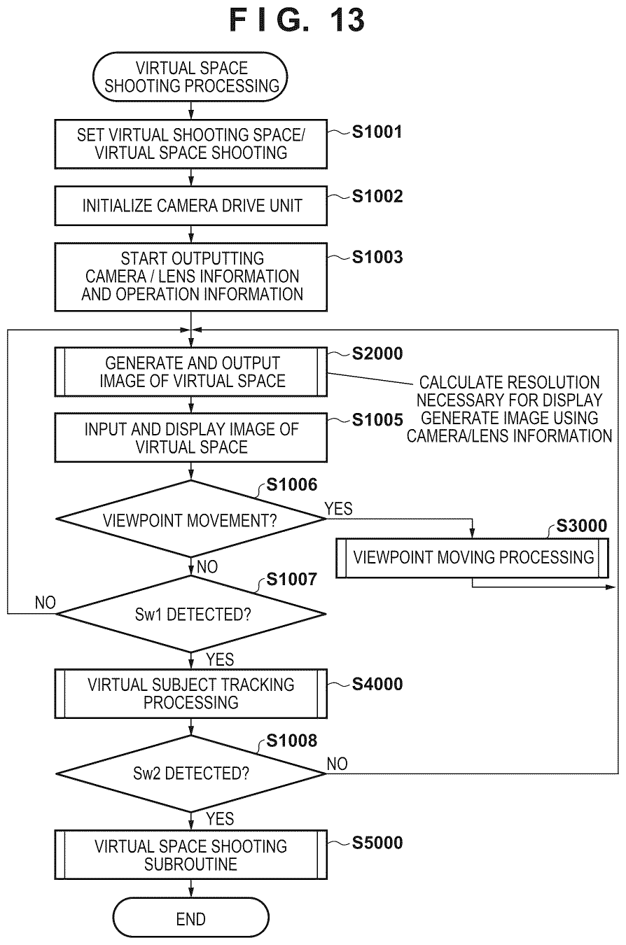

The flowchart of FIG. 13 illustrates the operations of the virtual space shooting processing illustrated in S1000 of FIG. 8. The virtual space shooting processing is processing for generating an image by extracting information of a certain moment in the virtual space that changes together with the passage of time. Shooting the virtual space does not require an actual imaging optical system or an actual image sensor, but to facilitate description, terminology similar to that used to describe shooting in the real space will be used. For example, image generation in the virtual space is expressed using shooting and image capturing. Specifically, FIG. 13 illustrates the processing from an operation before image capture to display an image in a virtual space on the display device 131 of the camera 100 as a live view image to when still image capture is performed. The camera CPU 121 and the CPU 1001, computers, execute the present processing according to a computer program. Hereinafter, the entities performing the operations are the camera CPU 121 and the CPU 1001 unless otherwise mentioned.

In S1001, setting is performed relating to virtual space shooting including the virtual shooting space where the act of taking pictures is performed and the devices and the like used at this time. Setting of the virtual shooting space includes arranging the foreground object at an appropriate position with respect to the background object as described above using FIG. 7. Also, information relating to the position and shape of the foreground object that changes over time is obtained. The foreground object to be arranged may be one or may be a plurality.

Also, setting of the virtual space shooting includes the camera CPU 121 outputting model information of the devices in operation to the external computation apparatus 1000 as settings for the camera and lens used in the virtual space shooting. In a case where a model different from the model actually in operation is used as the device used in the virtual space shooting, a unique symbol for the model is set by the user, and the camera CPU 121 outputs the set information to the external computation apparatus 1000. Accordingly, the operator (user) can have an image capturing experience using a camera and lens that they do not actually own. For example, while operating a camera mounted with a short focal length, that is, a wide-angle lens, in the virtual space, an image capturing experience of having a telephoto lens with a long focal length mounted can be had. Operation of a model different from the model actually in operation is not limited to the lens, and this may also be used for the camera or for both.

Accordingly, regardless of the weight and size of the device, an image capturing experience with more freedom can be realized. In a similar manner, by using a camera not actually owned, the performance and the like of the camera enhanced by a new function or a newly implemented algorithm can be experienced.

Also, setting the virtual space shooting includes setting the initial value of the viewpoint position and direction (position and direction in the virtual space of the camera) for when the virtual space shooting is started. A position separated an appropriate distance need only be set as the initial value based on information such as the type of the foreground object described above. Also, a preset shooting position in the background object may be set as the initial value.

In S1002, the CPU 1001 performs a camera drive unit initialization instruction with respect to the camera 100. The details will be described below.

In S1003, the CPU 1001 obtains the camera information, the lens information, and the camera and lens operation information from the camera 100 and the camera/lens information storage apparatus 2000.

### Description of Communication Between Camera/Lens and External Computation Apparatus

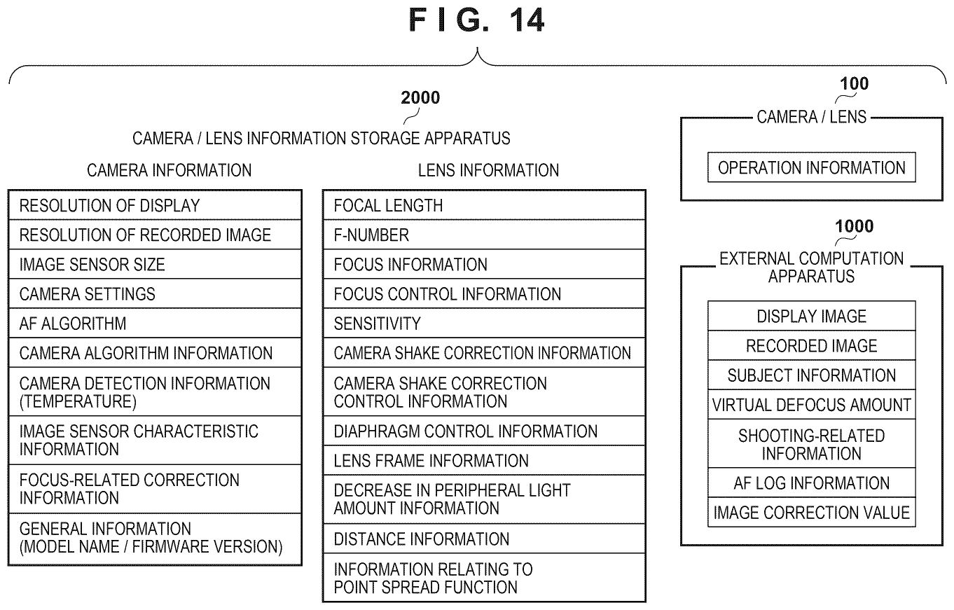

An example of information communicated between the camera/lens and the external computation apparatus 1000 will now be described using the table of FIG. 14.

The information of the camera/lens information storage apparatus 2000, the information of the camera/lens, and the information of the external computation apparatus 1000 will be described. The camera/lens information storage apparatus 2000 records camera information and lens information. The camera/lens information storage apparatus 2000 also obtains information from the camera/lens and stores this.

Camera information includes the resolution of the display obtained from the camera 100 in advance; the resolution of the recorded image; the image sensor size; and settings for autofocus (AF) modes such as distance measuring frame mode, one-shot mode, and servo mode and continuous shooting. Also included are camera settings such as shooting difficulty settings relating to shooting set by the user, the AF algorithm, camera algorithm information such as the drive sequence for automatic exposure (AE) and continuous shooting, and camera detection information such as temperature and the like. Also included is image sensor characteristic information such as S/N information for ISO sensitivity and signal characteristic correction of the image sensor and shading correction values representing unevenness in the light amount. Also included are defocus conversion coefficient for converting image misalignment amount to defocus amount, focus-related correction information, information relating to correction of a best focus position for correcting misalignment between the focus detection result and a best image plane position, and focus-related correction information which is defocus error information. Also included is general information such as the model name of the camera/lens and the firmware version of the various types of algorithms.

Lens information includes the focal length range, current value, and resolution; the f-number range, increments, and current value; the focus lens drive range and current focus information; and focus control information relating to the control characteristics of focus driving. Also included are sensitivity for converting the focus lens drive to image plane movement amount; camera shake correction information relating to camera shake correction range, current value, and correction resolution; and camera shake correction control information relating to control characteristics of camera shake correction. Also included are diaphragm control information relating to control characteristics of diaphragm driving, frame information (position, diameter) relating to a vignetting, decrease in peripheral light amount information, distance information relating to the focus lens position and distance, and information relating to the point spread function.

The camera/lens includes operation information generated by the user operating the camera/lens main body. Operation information is information relating to framing, zooming, focusing, and releasing operations and other button operations. This operation information is transmitted to the external computation apparatus 1000, and is applied in the virtual image generation.

The external computation apparatus 1000 obtains the camera information, the lens information, and the operation information and generates a display image, a recorded image, subject information which is shooting difficulty information, the virtual defocus amount, and various types of shooting-related information.

The lens information to obtain includes information relating to the settable range and current position of the focal length, the f-number, and the focus lens position; the mechanical controllability of the lens; and the movement amount (sensitivity) of the image forming surface in conjunction with movement of the focus lens. Also included are frame information relating to vignetting (position, diameter), decrease in peripheral light amount information, shooting distance (subject distance to be in focus) information, and the like.

Also the camera information to be obtained includes a model name, firmware version, resolution of the EVF image and still image, and size of image sensor as general information. Also included are camera settings information such as settings for an AF frame for setting the range for AF, settings for the AF modes such as one-shot and servo AF, and settings for the continuous shooting mode such as continuous shooting speed. The camera settings information includes difficulty information relating to shooting (shooting difficulty setting) set by the user.

Also, the correction value of the signals used in focus detection for autofocus include a correction value for signal characteristics dependent on the characteristics of the image sensor 107, a shading correction value representing light amount unevenness, and a defocus conversion coefficient for converting the phase difference in the pair of signals to a defocus amount. Also included is a best focus correction value for correcting misalignment between the focus detection result and the best image plane position.

Also, the camera information includes, as characteristic information of the image sensor 107, S/N information of the signals per ISO sensitivity, various types of algorithm information such as the continuous shooting sequence and photometry when shooting with the camera, autofocus-related algorithm information such as AF frame selection and predictive AF, and the like. One or more of these pieces of information change in conjunction with operation of the camera. Thus, for information with a possibility of changing, from S1003 onward, they are periodically obtained.

Also, the camera/lens operation information includes information relating to the operation amount and operation speed of operations such as panning, zooming, and focusing of the camera held by the user and information relating to a button press operation such as a release operation, that is, an image capture instruction.

Returning to the description of FIG. 13, in S2000, based on the settings performed up until this point, an image of the virtual space is generated and output to the camera 100. The present processing is described below in detail.

In S1005, the camera CPU 121 obtains the image output in S2000 and displays the image on the display device 131. The image to be displayed is thereafter updated at 60 fps, for example. By using the camera operation information and the lens operation information together, images with different displayed virtual space ranges are updated in the display device 131 in response to panning and zooming of the camera.

In S1006, it is determined whether or not the mode is a mode (viewpoint movement mode) in which the viewpoint in the virtual space observed via the display device 131 moves. In a case where the mode is a mode in which viewpoint moving processing is executed, S1006 becomes “Yes”, and the processing proceeds to S3000. In S3000, viewpoint moving processing to determine the position of the camera and the shooting direction in the virtual space is executed. The details will be described below. When S3000 ends, the processing returns to S2000.

In the case of “No” in S1006, the processing proceeds to S1007. As in S13 of FIG. 9, in S1007, the camera CPU 121 determines whether or not the switch Sw1 for instructing to start image capture preparations has been turned on via a half-press operation of the release switch included in the operation switch group 132. In a case where the switch Sw1 has not been turned on, the camera CPU 121 returns to S2000 and repeats the determination to monitor the timing of when the switch Sw1 will be turned on. In a case where the switch Sw1 has been turned on, the camera CPU 121 advances the processing to S4000 and executes virtual subject tracking processing.

In S4000, various types of correction are performed on the image to be generated in response to a user operation, subject movement, and the like, and shooting of the subject, which is at least a portion of the foreground object, can be performed. The present processing is described below in detail.

As in S15 of FIG. 9, in S1008, whether or not the switch Sw2 for instructing to start image capture operations has been turned on via a full-press operation of the release switch is determined. In a case where the switch Sw2 has not been turned on, the camera CPU 121 returns the processing to S2000. In a case where the switch Sw2 has been turned on, the processing proceeds to S5000, and a virtual space shooting subroutine is executed. The details of the virtual space shooting subroutine will be described below. When the virtual space shooting subroutine ends, the present processing ends.

### Subroutine of Virtual Space Image Generation and Output

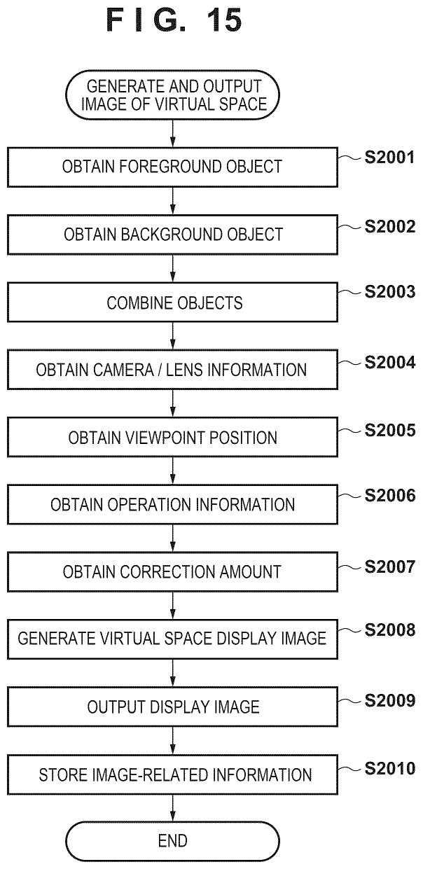

Next, a virtual space image generation and output subroutine executed by the external computation apparatus 1000 in S2000 of FIG. 13 will be described using the flowchart illustrated in FIG. 15.

In S2001, the CPU 1001 obtains a foreground object. First, the user selects a type of subject they wish to shoot (for example, human, animal, vehicle, or the like) using the virtual space reproduction apparatus 1100. Next, the user selects the shape, color, and the like of the subject and also selects how to move the subject (speed, movement direction, and the like). The user interface for selecting may be configured so that information stored in the foreground object storage unit 1101 of the virtual space reproduction apparatus 1100 is displayed on the display device 131 of the camera so that the user can select via an operation. As described above, the foreground object, a three-dimensional model of the subject, is obtained via any of a plurality of methods.

In S2002, the CPU 1001 obtains the background object. As described above, the background object, a three-dimensional model of that other than the subject, is obtained via any of a plurality of methods.

In S2003, the CPU 1001 performs combining of the objects. Combining the objects corresponds to a processing of combining the foreground object and the background object described above. The objects are combined by determining how to arrange the background object in the three-dimensional space and where to arrange the foreground object in the three-dimensional space with respect to the background object. First, the background object is arranged in the three-dimensional space, and the user selects where to arrange the foreground object in the three-dimensional space. The foreground object can be arranged at only a position arrangeable with respect to the background object (for example, at a position other than inside the background object) from the three-dimensional model of the background object and the arranged coordinates in the three-dimensional space. The user selects a position to arrange the foreground object from the three-dimensional space of the background object. In this manner, combining of the objects is performed.

In S2004, the CPU 1001 obtains the camera/lens information. The camera/lens information to be obtained here is information for the virtual space image generation and output described below. Specifically, the camera information includes the display resolution of the display device 131 for displaying, the size and number of pixels of the image sensor of the camera, and the like. Also, the lens information includes the focal length range and current value, the diaphragm range and current value, the focus lens range and current value, and information relating to a decrease in peripheral light amount and point spread function.

In S2005, the CPU 1001 obtains the viewpoint position information. To generate the virtual image described below, virtual viewpoint information in a three-dimensional space is obtained. The virtual viewpoint information may be a predetermined value as an initial value or may be a virtual viewpoint changed via the viewpoint moving processing of S3000 described below.

In S2006, the CPU 1001 obtains the camera/lens operation information. Operation information is information relating to framing, zooming, focusing, and releasing operations and other button operations.

In S2007, the CPU 1001 obtains the image correction amount. The image correction amount is a correction amount relating to framing, zooming, and/or focusing. The details will be described below when describing the virtual subject tracking processing subflow of S4000. Here, a predetermined initial value for the image correction amount is obtained.

In S2008, the CPU 1001 performs virtual space display image generation. An image is rendered based on the foreground object, the background object, and the viewpoint position information described above arranged in the three-dimensional space. What range to make an image as the display image includes determining a range to make a display image from the information of the focal length as the lens information described above, the image sensor size as the camera information, the resolution of the display portion, the camera settings, and framing and zooming via operation information. Also, a range is determined as the display image by correcting the range using the image correction amount. Also, a display image with a changed f-number and defocus amount is generated from, as lens information, the f-number information, the decrease in peripheral light amount information, the information relating to the point spread function, the focus lens position information, and image correction amount information relating to focusing. The display image is an image that is not recorded and different from the recorded image described below. Thus, after the display image range is correctly determined, the display image may be easily generated with less information than that used in recorded image generation, without using one or more pieces of other information such as the focus lens position information and the decrease in peripheral light amount information.

In S2009, the CPU 1001 outputs the display image generated in S2008. The output image is transmitted from the external computation apparatus 1000 to the camera 100 and displayed on the display device 131.

In S2010, the CPU 1001 stores image-related information. The image-related information is information including subject information, shooting-related information, virtual defocus amount, and AF log information. The image-related information is temporarily stored in the RAM 1003 of the external computation apparatus 1000 and recorded as image-related information in the virtual space shooting subroutine described below. The details will be described below.

As described above, the image generation of the virtual space of S2000 of FIG. 13 and the output processing ends. In the present embodiment, image generation of the virtual space and output are performed in the external computation apparatus 1000, but image generation of the virtual space and output processing may be performed in the camera 100.

### Subroutine of Virtual Subject Tracking Processing

The virtual subject tracking processing of S4000 of FIG. 13 will be described using the flowchart of FIG. 16.

Of the various types of correction described below, in correction relating to framing, correction relating to framing is performed so that the subject appropriately fits in the displayed field of view of the camera in a case such as where the framing of the user is off and the subject to be captured is outside of the screen or cut off.

In correction relating to zooming, correction relating to zooming is performed so that the subject is displayed on the screen at an appropriate size in a case such as where the subject to be captured becomes too big or too small for the screen due to zooming (lens focal length) by the user being off. Also, not only zooming correction of a single timing, but also correction of shooting (zooming shooting) while keeping a subject coming closer, for example, inside the screen at a certain size is performed. In a case where a consecutively captured image is choppy when the user perform zoom, in order to realize a smooth focal length change, zooming correction taking into consideration the before and after timing is also performed, for example.

In correction relating to focusing, correction is performed on a focus that is out of focus when the speed of the subject is fast and the speed change is great due to the result of the tracking algorithm (tracking limit performance) at the time of autofocus, for example. Accordingly, an in-focus image or an image with reduced blurriness can be obtained. Also, correction is performed on being out of focus due to a focusing operation by the user at the time of manual focus. Also, correction is performed on a phenomenon in which the focus moves away from the subject caused by the effects of the framing by the user being off or the like and causing focus lens driving with respect to the background region.

First, in S4001, the CPU 1001 obtains the camera/lens information from the camera/lens information obtaining unit 1202. The camera/lens information obtained here is information for determining on or off for the correction described below, obtaining the subject difficulty information, and calculating the correction amount. Specifically, the camera information includes the shooting difficulty settings relating to shooting set by the user and the like as well as the camera settings relating to correction and the like. The lens information includes the focal length, the focus lens position, information relating to setting the camera shake correction switch to on or off, and the like.

In S4002, the CPU 1001 obtains the settings information relating to correction using the camera/lens information obtained in S4001. The settings information relating to correction includes settings information such as an on or off setting relating to correction in the camera, a mode setting such as for difficulty settings, and an on or off setting for the camera shake correction switch for the lens.

In S4003, the CPU 1001 detects framing and obtains information such as whether the camera is swinging (whether the camera is panning) and in what direction and at what speed is the camera swinging.

In S4004, the CPU 1001 detects zooming and obtains information such as whether the zoom lens is operating and in which direction of tele or wide and at what speed the zoom lens is operating.

In S4005, the CPU 1001 detects focusing and obtains information such as whether the focus ring is being operated and in which direction of either the close direction or infinite direction and at what speed the focus ring is being operated.

Also, the detection in S4003 to S4005 is not only for manual operations by the user but also includes auto operations (autoframing/autozoom/autofocus or the like) performed on the camera side.

In S4006, the CPU 1001 sets the subject area. Here, which foreground object to make the main subject is determined from among the images generated by the object combining unit 1103, and the area for AF is also simultaneously set. Also, by determining the main subject, information relating to the speed, acceleration, angular velocity, and angular acceleration relating to the subject; size of the subject; contrast value of the subject; and distance between the subject and the user can be obtained from the foreground object storage unit 1101.

Various methods may be used for the subject area setting method, and in the present embodiment, setting can be performed in a three-dimensional space. On the other hand, with a camera at the time of real space shooting, the method is set based on the framing by the user or the detection result of the subject detection unit in an image (two-dimensional) space. In shooting in a virtual space according to the present embodiment, the subject area setting method need only be set, as described above, according to the information held by the foreground object and information such as existing closer or more to the center of the range to be captured. Also, as with the time of real space shooting, a main subject may be detected from the obtained image. Accordingly, the performance of the camera at the time of real space shooting can be better reproduced.

In S4007, the CPU 1001, in the image correction amount calculation unit 1206, determines whether to turn correction on or off from the various types of information obtained in S4002 to S4006. For example, in S4002, if the information relating to correction in the camera is on, correction is turned on. However, if this is off, then correction is turned off. Also, the intention of which subject is targeted, whether a subject is being followed via framing, and whether a different subject is being switched to for framing are extracted and determined from the framing information detected in S4003 using the user intention extraction unit 1262. Also, in the case of the former, if correction is turned on, a framing mistake by the user can be compensated for via correction. In the case of the latter, if correction is turned off, framing (keeping in the field of view) can be performed on a different subject as per user intention.

Also, during manual operation such as manual zoom and manual focus, from the zooming and focusing information detected in S4004 and S4005, if it is determined that the intention of the user is strong, correction is turned off. In a determination method, during the operation of an automatic function such as autozoom and autofocus, if it is determined that the intention of the user is weak, correction is turned on.

As described above, by turning correction off in a case where it is determined that the intention of the user is strong, an image capturing result and image capturing experience with a similar feel to that of the user operating can be provided. Also, even if correction is turned on in a case where the intention is weak, a good captured image can be obtained via correction without the image capturing experience of the user being diminished. Also, in a determination method, in a case where the correction capability value is defined in the camera itself, correction is turned on only if the camera correction capability value is compared to the shooting difficulty described below and it is greater than the shooting difficulty.

In S4100, the CPU 1001 obtains the shooting difficulty information using the shooting difficulty calculation unit 1261. By using the shooting difficulty information to calculate various types of correction amounts described below, for example, by the correction amount being lower when the shooting difficulty is higher, when the subject has a high difficulty, it becomes hard to continually capture the subject in the screen and continually focus on the subject. On the other hand, when the subject has a low difficulty, by setting the correction amount to a high amount, a good image capturing result is obtained via correction even if a large mistake is made. Accordingly, the shooting success rate with respect to a subject with low difficulty can be increased.

With a subject with a low difficulty, often it is not a situation where the user is enjoying the image capturing experience of concentrating on shooting and being immersed. Thus, even with an increased correction amount, the image capturing experience is not diminished, and bad photos can be reduced. However, with a subject with a high difficulty, if the correction amount is increased, the satisfaction from the image capturing experience may be diminished, and thus in the present embodiment, correction is reduced. As with camera shooting in real space, adjusting the correction amount according to the subject difficulty leads to being able to provide a more realistic image capturing experience.

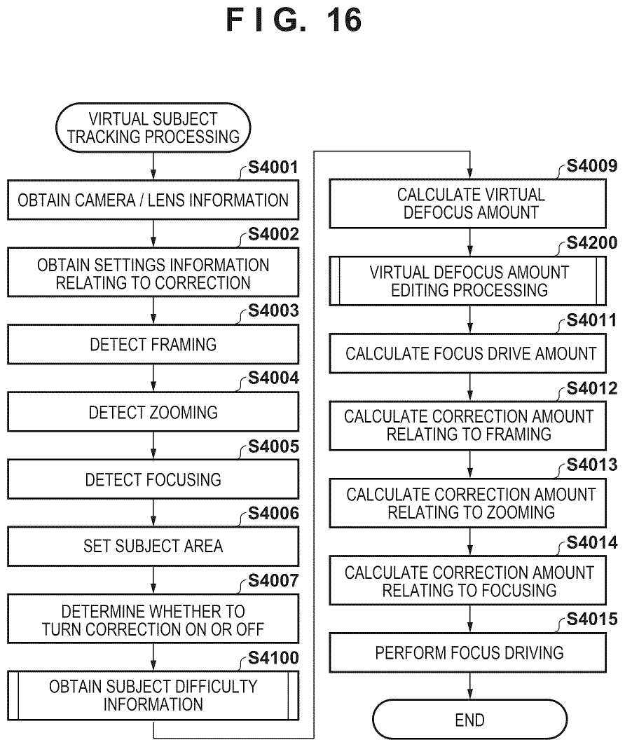

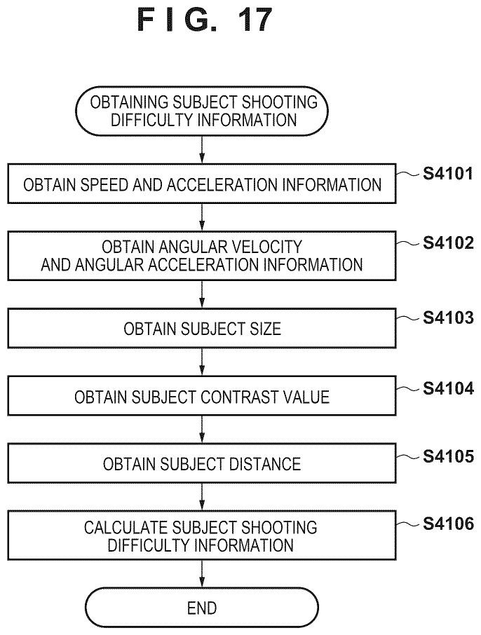

Obtaining the shooting difficulty information will now be described using FIG. 17.

The CPU 1001, in S4101, obtains the subject speed and acceleration information from the foreground object storage unit 1101 and, in S4102, obtains the subject angular velocity and angular acceleration information from the foreground object storage unit 1101. This information may be information of each timing or may be information with a fixed definition such as the maximum speed and maximum acceleration, with higher values meaning higher shooting difficulty calculated in S4106.

In S4103, the CPU 1001 obtains subject size information from the foreground object storage unit 1101.

In S4104, the CPU 1001 obtains a subject contrast value from the foreground object storage unit 1101. The shooting difficulty is higher when the contrast value is lower.

In S4105, the CPU 1001 obtains the distance between the subject and the user from the information from the foreground object storage unit 1101 and the information of the viewpoint information obtaining unit 1201. By combining the information of zooming (focal length) obtained in S4001 or S4004 and the subject size information obtained in S4003, the subject size on the imaging plane is determined. The shooting difficulty is higher when this value is lower. Also, a difference in the site of the subject (person's eye or face) affects the shooting difficulty.

In S4106, the CPU 1001 calculates the subject shooting difficulty information from the information obtained in S4101 to S4105. The shooting difficulty information defined here may be defined as one piece of information encompassing all elements. It may also be defined as a plurality of types of information (framing difficulty, zooming difficulty, focusing difficulty, and the like) to correspond to each of correction relating to framing, correction relating to zooming, and correction relating to focusing as described below. The shooting difficulty information may be calculated from the various types of information in this manner, and the difficulty as is may be stored in the foreground object storage unit 1101. Also, in the present embodiment, the shooting difficulty is calculated each time the subject speed or distance changes (the shooting difficulty changes). However, this may be defined as a constant fixed shooting difficulty.

Returning to FIG. 16, in S4009, the CPU 1001 calculates a virtual defocus amount in the subject area set in S4006. The calculated virtual defocus amount may be a defocus map calculated from a plurality of areas as described using FIG. 5 or may be a single output for a single site such as the subject face or the like. In the case of the former, processing to select one area from a plurality of areas is provided, but in the present embodiment, this is not described in detail.

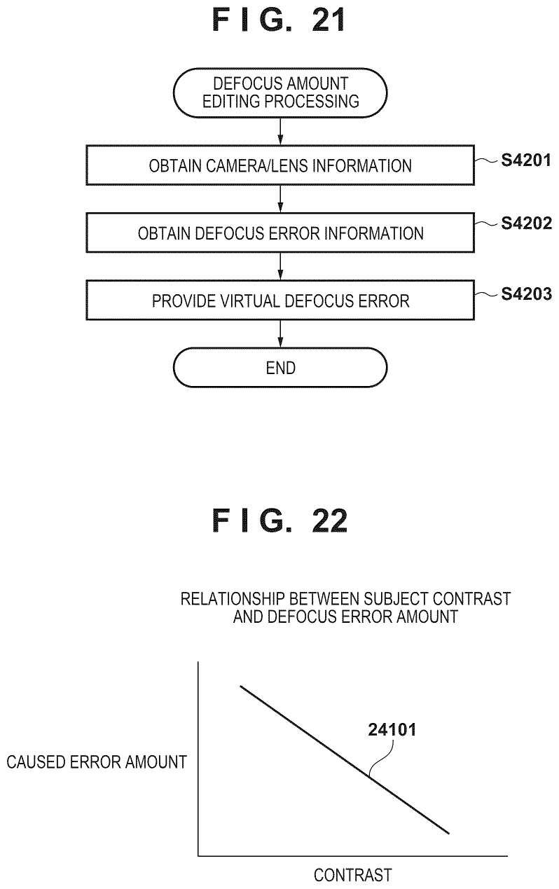

In S4200, the CPU 1001 executes editing processing of the virtual defocus amount. The details will be described below using FIG. 21.

In S4011, the CPU 1001 calculates the focus drive amount. The focus drive amount may be a value obtained by converting to a focus lens drive amount based on the virtual defocus amount calculated in S4009. Also, a future subject position may be predicted from the subject position in a plurality of previous frames, and the focus drive amount may be set with respect to the predicted position. Various methods can be used for the prediction method, and this will not be described as it is not the focus on the present embodiment.

In virtual space shooting, a real focus lens does not need to be driven. Thus, the desired focus state can be instantly switched to without needing time to perform focus driving. However, in the present embodiment, a goal is to provide the user an experience similar to that of shooting in a real space by using a camera that can shoot in a real space to perform shooting in a virtual space. Thus, time is taken to execute the processing to change the focus state during shooting (for example, focusing on an unfocused subject). The time taken for focus driving may be set to a time in accordance with the function/performance of the camera and lens actually used using the camera/lens information or may be set assuming a virtual camera and lens.

In S4012 to S4014, the CPU 1001, in the image correction amount calculation unit 1206, calculates the various types of correction amounts.

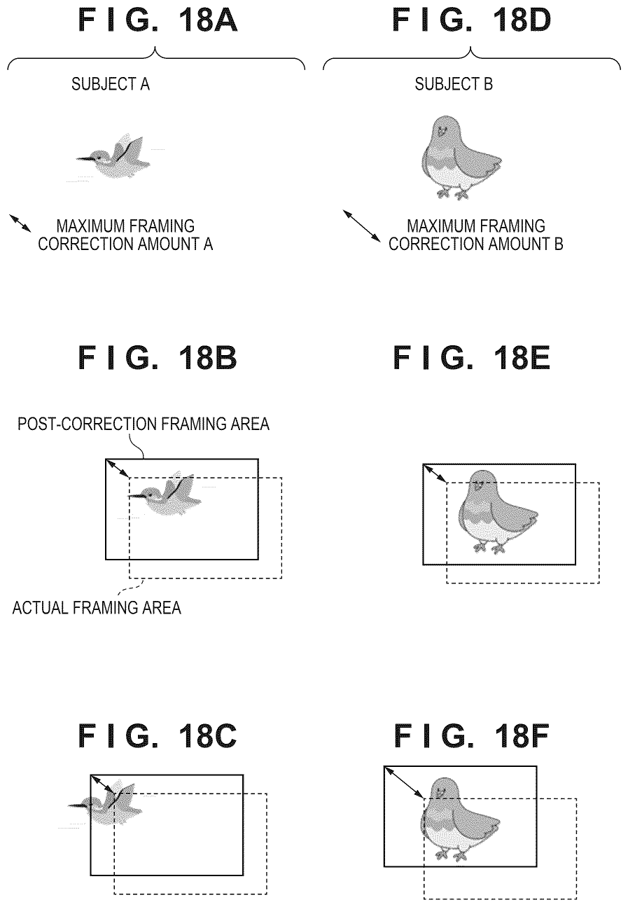

In S4012, the CPU 1001 calculates the correction amount relating to framing. The correction relating to framing will now be described using FIGS. 18A to 18F.

When a subject A of FIG. 18A and a subject B of FIG. 18D exist and the subject A is defined as having a higher shooting difficulty, according to the shooting difficulty, the maximum correction amount for framing is less for the subject A (maximum framing correction amount A<maximum framing correction amount B). The rectangular dashed line areas in FIGS. 18A to 18F are areas of actual framing by the user, and the solid line rectangular areas are framing areas after framing correction has been applied. In this case, in FIG. 18B, the framing of the user with respect to the subject A is off, but by performing correction within a maximum framing correction amount A, the subject A can be fit in the screen in the post-correction framing area. On the other hand, in FIG. 18C, the framing of the user with respect to the subject A is more off, and the subject A cannot be fit in the screen even by applying the maximum framing correction amount A.

Next, using the subject B as an example, in FIG. 18E, the framing by the user is only slightly off. Thus, as in FIG. 18B, the post-correction framing area can fit the subject B in the screen. In FIG. 18F, the offset amount is great, and in the case of the subject A, since the maximum framing correction amount A is less than the offset amount, the correction is insufficient. In such a case, as illustrated in FIG. 18F, since the offset amount is within a maximum framing correction amount B, in the post-correction framing area, the subject B can be fit in the screen. In this manner, by changing the correction amount for framing according to the shooting difficulty, a realistic image capturing experience can be provided in which framing is more difficult with subjects of higher shooting difficulty.

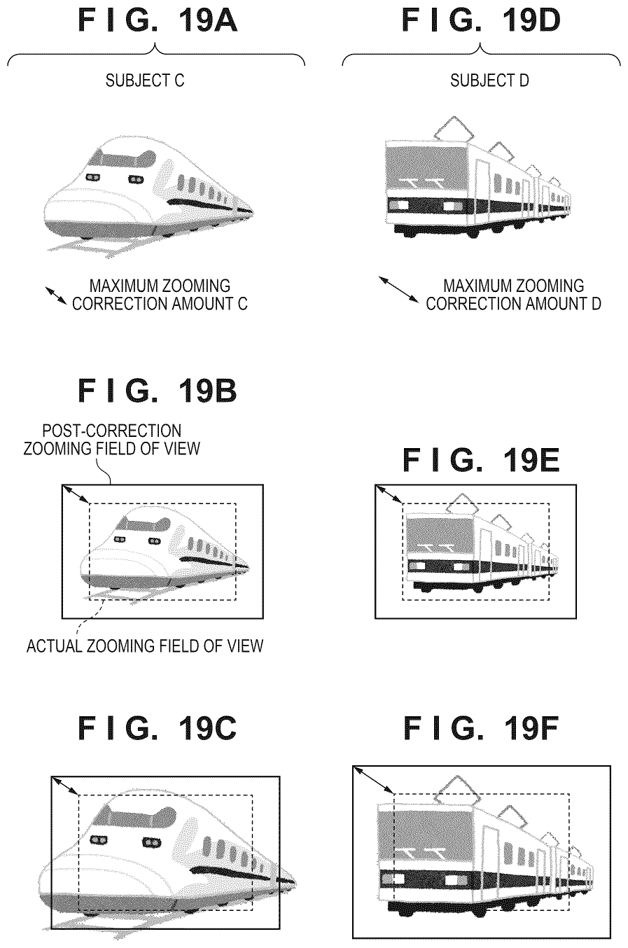

Returning to the description of FIG. 16, in S4013, the CPU 1001 calculates the correction amount relating to zooming. The correction relating to zooming will now be described using FIGS. 19A to 19F.

When a subject C of FIG. 19A and a subject D of FIG. 19D exist and the subject C is defined as having a higher shooting difficulty, according to the shooting difficulty, the maximum correction amount for zooming is less for the subject C (maximum zooming correction amount C<maximum zooming correction amount D). The rectangular dashed line areas in FIGS. 19A to 19F are areas adjusted by actual zooming by the user, and the solid line rectangular areas are fields of view after zooming correction has been applied. In this case, in FIG. 19B, the zooming of the user with respect to the subject C is off, but by performing correction within a maximum zooming correction amount C, the subject C can be fit in the screen in the post-correction zooming field of view. On the other hand, in FIG. 19C, the zooming of the user with respect to the subject C is more off, and the subject C cannot be fit in the screen even by applying the maximum zooming correction amount C.

Next, using the subject D as an example, in FIG. 19E, the zooming by the user is only slightly off. Thus, as in FIG. 19B, the post-correction zooming field of view can fit the subject D in the screen. In FIG. 19F, the offset amount is great, and in the case of the subject C, since the maximum zooming correction amount C is less than the offset amount, the correction is insufficient. In such a case, since the offset amount is within a maximum zooming correction amount D, in the post-correction zooming field of view, the subject D can be fit in the screen. In this manner, by changing the correction amount for zooming according to the shooting difficulty, a realistic image capturing experience can be provided in which zooming to continuously keep a subject in a field of view is more difficult with subjects of higher shooting difficulty.

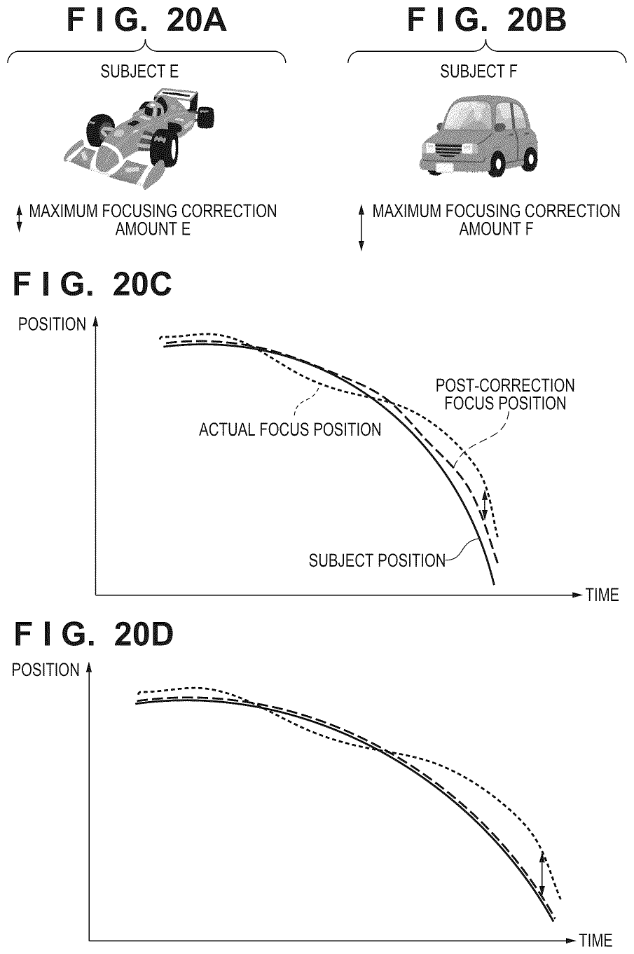

Returning to the description of FIG. 16, in S4014, the CPU 1001 calculates the correction amount relating to focusing. The correction relating to focusing will now be described using FIGS. 20A to 20D.

When a subject E of FIG. 20A and a subject F of FIG. 20B exist and the subject E is defined as having a higher shooting difficulty, according to the shooting difficulty, the maximum correction amount for focusing is less for the subject E (maximum focusing correction amount E<maximum focusing correction amount F). Here, FIG. 20C is a diagram representing the subject E approaching the user from far away as time passes, and FIG. 20D is the same for the subject F. The solid line is the path of the position of each subject, the dotted line is the path of the focus moved to focus on the subject (actual focus position path), and the dashed line is a path after correction has been performed on the focus.

If the solid line of the subject position and the dashed line or the dotted line match, this means that an image with the subject in focus can be captured. The subject position and the actual focus position being offset is usually caused by the focusing operation by the user in the case of manual focusing or caused by the result from the tracking algorithm (tracking limit performance) by the camera in the case of autofocus. In such cases, examples of the cause of this include the speed of the subject being fast and the change in speed being great. Thus, as illustrated in FIGS. 20A to 20D, the autofocus reaches the tracking limit as time passes, and the subject position and the real focus position offset from one another.

In FIG. 20C, the actual focus position is offset with respect to the subject E, but the post-correction focus position matches the subject position in a range within a maximum focusing correction amount E. However, as time passes and the subject position comes closer, the offset amount of the actual focus position increases until ultimately the correction using the maximum focusing correction amount E is insufficient and focusing cannot be performed.

On the other hand, in FIG. 20D, even when the offset of the actual focus position with respect to the subject F is great, since it is within the range within a maximum focusing correction amount F, an image with the subject F in focus can be captured all of the way to the end. Also, as described above, in correction relating to focusing, there exists being out of focus due to a manual focusing operation and being out of focus due to a background area or the like being focused on due to an offset in framing. Correction for these may be a correction amount equal to the correction value for being out of focus due to tracking limit performance or may be a different correction amount. Also, considering a case of both causes for being out of focus occurring at the same time, the correction amounts for each cause may be combined and used. In this manner, by changing the correction amount for focusing according to the shooting difficulty, a realistic image capturing experience can be provided in which focusing is more difficult with subjects of higher shooting difficulty.

In calculating the various types of correction amounts in S4012 to S4014 described above, as long as detection of the switch Sw1 in the virtual space shooting processing of FIG. 13 continues, the various types of correction amounts may be calculated using the previous recorded image information and previous image correction amounts stored in the storage unit 1004. In this manner, continuity in the correction results between images can be achieved, and a disconnect as a sequence of recorded images can be reduced.

Returning to the description of FIG. 16, in S4015, the CPU 1001 performs focus driving. Here, driving based on the focus drive amount calculated in S4011 and the correction amount relating to focusing calculated in S4014 is performed.

As described above, by changing the correction effect amount for the recorded image based on the user operation information, the subject information, and the camera information, shooting in the virtual space can be performed without diminishing the image capturing experience.

In the example of the present embodiment described above, the image correction amount is smaller when the shooting difficulty is higher. However, in another example, the image correction amount may be larger when the shooting difficulty is higher. In this manner, a successful photo (a photo in which the subject is in the field of view, a photo in which the subject is in focus, and the like) can be taken at a certain level regardless of the shooting difficulty. Also, whether the image correction amount is small when the shooting difficulty is high or whether the image correction amount is large when the shooting difficulty is high may be switched in the camera settings.

In this manner, processing such as defocus amount calculating and focus driving executed in the virtual subject tracking processing of S4000 can be run by an AF algorithm stored in the ROM of the camera 100. The processing may also be run by the AF algorithm of a different camera.

### Subroutine of Virtual Defocus Amount Editing Processing

Next, the virtual defocus amount editing processing subroutine of S4200 of FIG. 16 will be described using the flowchart illustrated in FIG. 21. In the present subroutine, processing is executed to provide an error amount according to the settings at the time of image capture and the image sensor characteristic information to the virtual defocus amount calculated in S4009. Normally, in shooting in a virtual space, the defocus amount is calculated from a known subject distance. Thus, a computation error equal to or greater than an error caused by the number of significant digits of each numerical value does not occur. However, in shooting in a real space, an error is regularly caused by the image sensor characteristics or an error is caused each time of shooting. In shooting in a virtual space, in order to reproduce the actions of a focus state similar to that when shooting in the real space, an error caused when shooting in the real space needs to be caused also when shooting in the virtual space. In the present embodiment, as described above, defocus editing processing is executed to provide an error to the virtual defocus amount that does not include an error calculated in S4009 in order to simulate shooting in the real space.

In S4201, the CPU 1001 obtains, as camera information of a virtual image generated in the virtual image generation apparatus 1200, the recorded image resolution, the image sensor size, the AF frame mode, the AF algorithm, and the S/N information per ISO sensitivity from the camera/lens information storage apparatus 2000. Also obtained is focus-related correction information including the information relating to the defocus conversion coefficient and the focus position correction and the defocus error information. Also obtained are, as the lens information, the lens focal length and resolution, the f-number, the focus lens information, the focus drive control information, and the sensitivity for converting the focus lens drive to image plane movement amount. Also obtained is camera shake correction control information, diaphragm control information, lens frame information, decrease in peripheral light amount information, and distance information relating to the distance to the focus lens position. Then, these are stored as information in the external computation apparatus 1000 in association with the virtual image.

In S4202, the CPU 1001 obtains the defocus error information stored in the RAM 1003. The defocus error information will be described below.

In S4203, the CPU 1001 provides the defocus error amount obtained in S4202 to the virtual defocus amount calculated in S4009 of FIG. 16. In a case where the virtual defocus amount is calculated for a plurality of focus detection areas, a defocus error amount is provided to the plurality of focus detection areas.

The defocus error information obtained in S4202 will now be described using FIG. 22. FIG. 22 is a graph illustrating the relationship between the contrast value of the subject obtained in S4006 of FIG. 16 and the error amount expected to be caused in the virtual defocus amount. Typically, in shooting in a real space, in a case where there is minimal pattern on the subject and the contrast is low, the error amount included in the detected defocus amount is great.

In FIG. 22, the horizontal axis represents the contrast of the subject and the vertical axis represents the caused error amount. A straight line 24101 indicates that the caused error amount is smaller when the contrast of the subject is higher (horizontal axis right direction). The relationship between the contrast and the error changes due to the gain applied to the signals set with an SN ratio of the pixel portion of the image sensor or the read out circuit portion, the number of pixels used in the focus detection signals, the ISO sensitivity, and the like. Thus, in the present embodiment, the relationship illustrated in FIG. 22 is stored per mode in which the SN ratio of the image sensor changes, specification of the focus detection signals, and ISO sensitivity. When stored, these may be stored as discrete values as a table, represented as a graph via a function, or stored as the coefficient of a function. Also, since the defocus conversion coefficient which is camera information changes, due to the f-number, lens frame information, and the like which are a portion of the lens information, the error amount described above changes. In the present embodiment, using the lens information and the camera information described above, the calculated error amount is multiplied by a predetermined coefficient. The predetermined coefficient is stored as a table of values of a ratio to a reference value. For example, using the f-number or lens frame information as an index, a table storing the defocus conversion coefficients and coefficients multiplied by the error amounts described above is stored, and the error amount is calculated according to the state at the time of shooting.

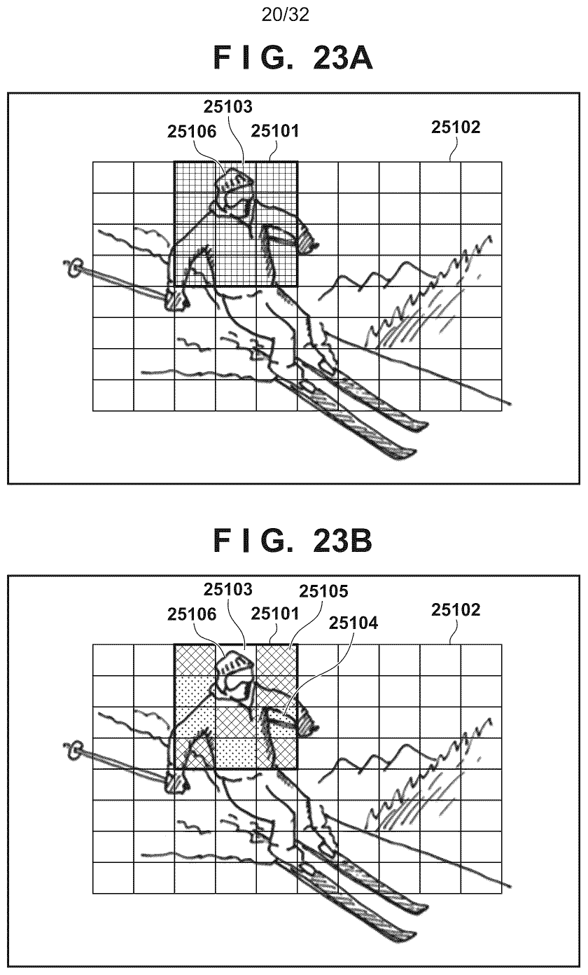

FIGS. 23A and 23B illustrate an example of virtual defocus in the case of not providing the virtual defocus error generated in S4203 of FIG. 21 and the case of providing the virtual defocus error with these examples superimposed on the main subject as a map.

FIG. 23A illustrates the case of not providing the virtual defocus error. In a virtual defocus map 25102, regarding the head portion focus position of a person 25106 in an AF frame 25101 of the virtual space image, the entire area of the AF frame 25101 indicates a focus area 25103 (horizontal and vertical grid-like pattern hatching).

FIG. 23B illustrates the case of providing the virtual defocus error. The area of the head portion of the person 25106 in the AF frame 25101 is indicated by the focus area 25103 and a front side focus position 25104 (diagonal grid-like pattern hatching) and a back side focus position 25105 (black dot hatching) area.

In FIG. 23A, all of the AF frame is a focus area. However, as illustrated in FIG. 23B, by providing the error, a front and back side focus AF frame is generated as well as the focus area.

In shooting a virtual image in this manner, by providing a defocus error according to a change in the camera/lens information and applying an algorithm of at the time of AF frame selection, a defocus detection result similar to that of when shooting in the real space can be obtained. In the present embodiment, to facilitate description, an example of providing a defocus error on a defocus map has been given. However, a defocus error may be provided to one AF frame. The error causes effects at the time of predictive AF and the like, and thus a similar effect can be expected. In this manner, in shooting in a virtual space, the behavior of focus adjustment similar to that of shooting in a real space can be reproduced, and a performance evaluation of a product, a check of new functions, and the like can be performed before purchasing the camera or lens.

In the present embodiment, to make shooting in a virtual space similar to a shooting result in a real space, a defocus variation is provided. However, providing an error is not necessary. In a case where it is not necessary to be similar to a shooting result in a real space, it is conceivable that an error is not provided, and in some cases, switching may be performed.

### Subroutine of Virtual Space Shooting

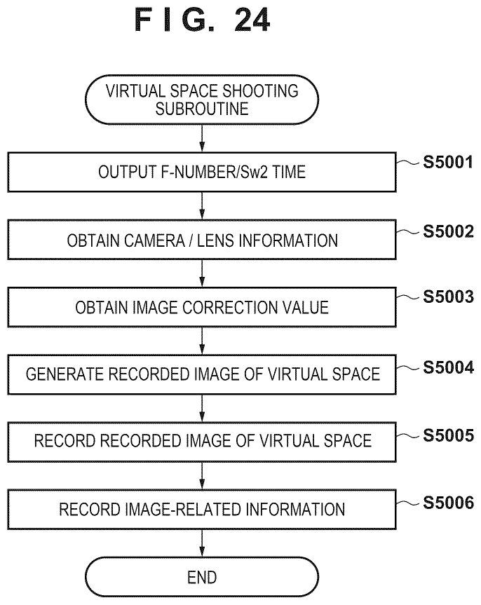

Next, a virtual space shooting subroutine executed by the external computation apparatus 1000 in S5000 of FIG. 13 will be described using the flowchart illustrated in FIG. 24.

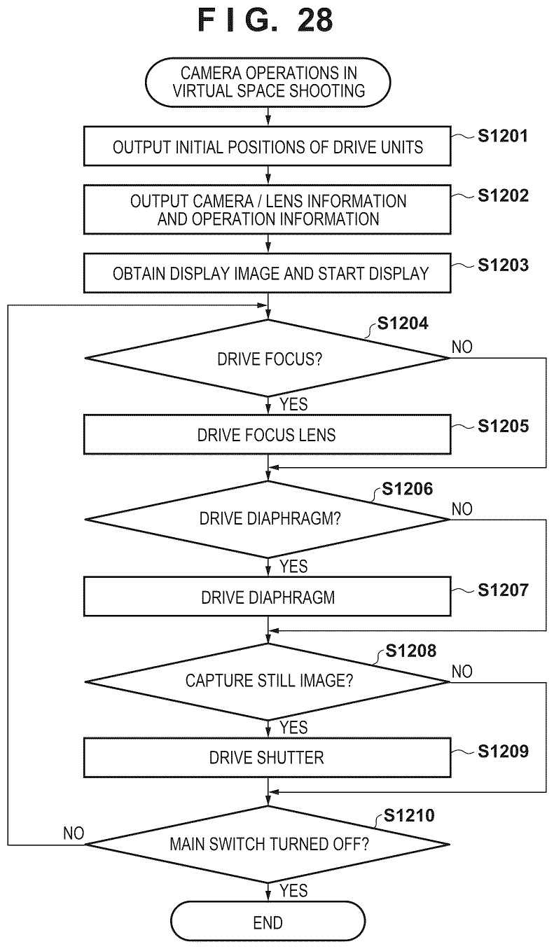

In S5001, the CPU 1001 outputs the set f-number and time at which the switch Sw2 was detected. The method for using this information will be described below in the actual camera operations in cooperation with the virtual space shooting operation of FIG. 28 described below.

In S5002, the CPU 1001 obtains the camera/lens information. Specifically, the camera information includes the resolution for recording and the size and number of pixels of the image sensor of the camera. The lens information includes the focal length range and current value, the f-number range and current value, the focus lens position range and current value, information relating to a decrease in peripheral light amount and point spread function, and the like.

In S5003, the CPU 1001 obtains the image correction value described above.

In S5004, the CPU 1001 generates a recorded image of the virtual space. An image is rendered from the viewpoint position information of the foreground object and the background object described above arranged in the three-dimensional space. What range to make an image as the display image includes determining from the focal length in the lens information described above, the image sensor size and resolution in the camera information, and the camera settings. Also, the recorded image is generated from the f-number information in the lens information, the decrease in peripheral light amount information, the information relating to the point spread function, and focus lens position information. The recorded image is different from the display image described above and, as it is an image for recording, is generated by correctly determining the recorded image range and also using various types of optical information such as the focus lens position information, the decrease in peripheral light amount information, and the information relating to the point spread function. The recorded image is different from the display image and does not need to be displayed in real time to the user. Thus, the generation of the recorded image may be later in time than the generation of the display image. Accordingly, the recorded image can be generated using more detailed data of the camera information and the lens information used to generate the display image.

In S5005, the CPU 1001 records a recorded image of virtual space in the storage unit 1004 of the external computation apparatus 1000. Alternatively, the recorded image generated in S5004 described above may be transferred to the camera 100 and stored in the flash memory 133 of the camera 100.

In S5006, the CPU 1001 stores various types of image-related information. The image-related information includes subject information (shooting difficulty information), shooting-related information, and information including the virtual defocus amount. The image-related information is stored in the storage unit 1004 of the external computation apparatus 1000. Alternatively, the image-related information may be transferred to the camera 100 and stored in the flash memory 133 of the camera 100. With this complete, the virtual space shooting subroutine ends.

### Virtual Space Shooting Based on Operation Information

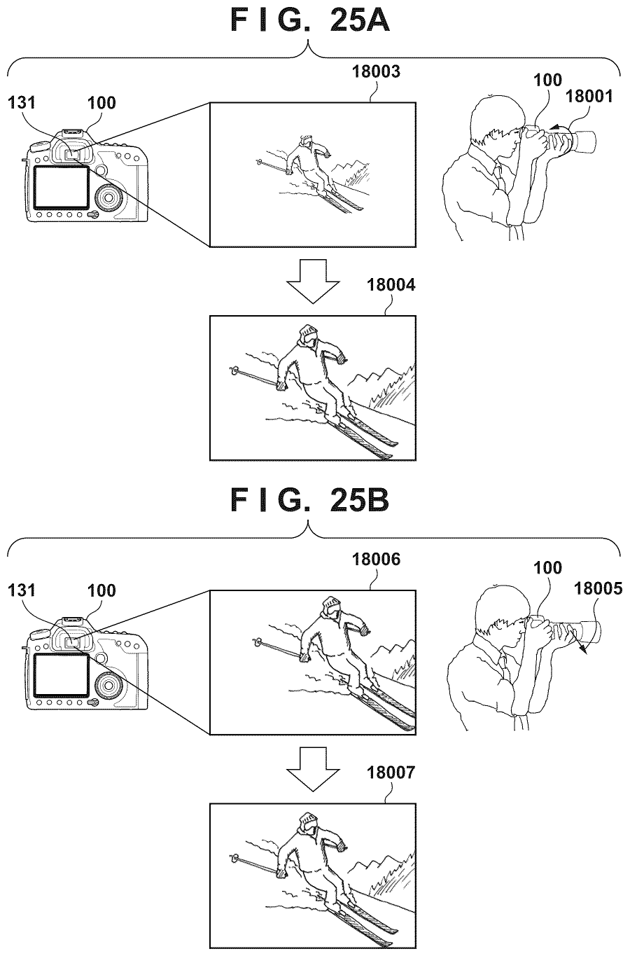

Virtual space shooting based on the operation information will now be described using FIGS. 25A and 25B. FIG. 25A illustrates an example of a zooming operation, and FIG. 25B illustrates an example of a framing operation.

In FIG. 25A, a still display image 18003 in a virtual space generated in the virtual image generation apparatus 1200 is displayed on the display device 131 of the camera 100. In a case where the user performs an operation to rotate the zoom ring of the lens and the focal length is changed to the telephoto side, the virtual image generation apparatus 1200 obtains the change in the focal length via the zoom ring operation as the operation information. Then, by changing the display range when the display image in the virtual space is generated, a display image 18004 in a virtual space based on the change in the focal length via the zooming operation by the user is generated and displayed on the display device 131.

In the present embodiment, since a display image in a virtual space is generated using the camera/lens information, a display image in a virtual space can be generated at a focal length range at which operation is impossible with the lens operated by the user. For example, by generating a display image in a virtual space using lens information of a telephoto lens with a long focal length even though the user is operating a lens with a short focal length, the experience of shooting with a telephoto lens with a long focal length can be had. Typically, a lens with a long focal length used in shooting in a real space is large, heavy, and expensive. However, in shooting in a virtual space according to the present embodiment, an image capturing experience can be provided without such constraints.

In FIG. 25B, a still display image 18006 in a virtual space generated in the virtual image generation apparatus 1200 is displayed on the display device 131 of the camera 100. FIG. 25B illustrates a case in which the user operates a framing operation of the camera/lens and moves the camera/lens in the direction of an arrow 18005, which is the horizontal direction. The virtual image generation apparatus 1200 obtains the framing information, which is the camera/lens position via the framing operation, as the operation information. Then, by changing the display range when the display image in the virtual space is generated, a display image 18007 in a virtual space based on the change in the framing via the framing operation by the user is generated and displayed on the display device 131.

In this manner, a display image in a virtual space based on the user operation information can be achieved via still image virtual space shooting.

### Subroutine of Viewpoint Moving

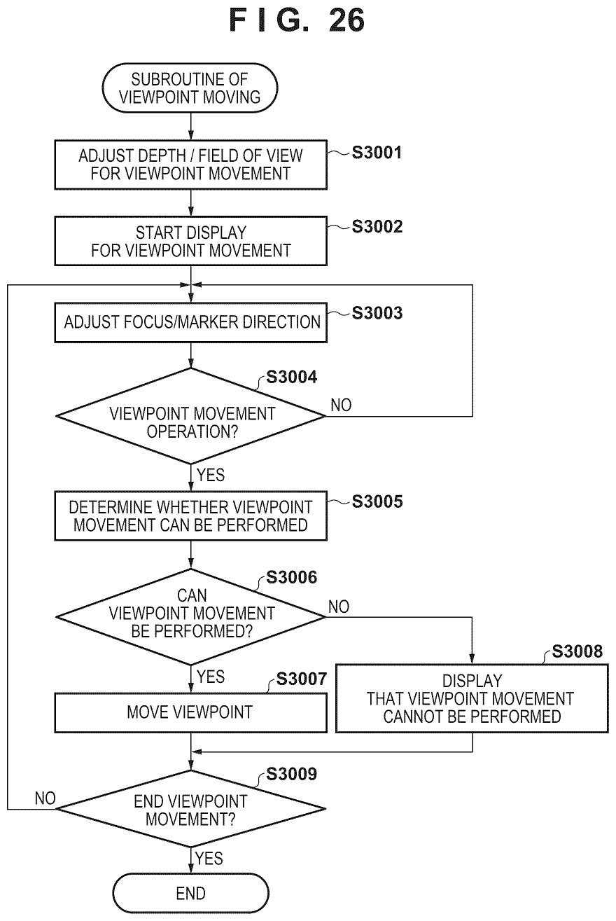

Next, the viewpoint moving processing subroutine of S3000 in FIG. 13 will be described using FIG. 26. Specifically, processing for changing the viewpoint position (position of the camera in the virtual space) when shooting in the virtual space is illustrated. The present processing is executed by the CPU 1001.

First, in S3001, the CPU 1001 adjusts the focus depth and field of view of the displayed image each time viewpoint movement is performed. When viewpoint movement is performed, it is preferable that the subject is easily visible in a wider range and the in-focus distance is easily checked. This is because, as described below, the viewpoint movement destination is set from an object in the field of view displayed on the display device 131 and in the in-focus distance. In the present embodiment, in S3001, the field of view is widened to the preset field of view, and the range of the focus distance is adjusted to a preset depth of field less than when in image capturing mode. The present processing makes the viewpoint movement operation easier, and thus may be omitted.

In S3002, the CPU 1001 displays an image in a virtual space based on the settings performed in S3001. An image is displayed with a viewpoint position set in advance to a viewpoint position of the shooting in the virtual space or to an initial position.

In S3003, the CPU 1001 adjusts the focus and the marker direction. First, in the focus adjustment, as described in S3001, a focused state in a range of a predetermined distance within the range to be captured is displayed, and the user performs a focus adjustment operation in a similar manner to when shooting. Specifically, with one marker (I(n,m)) for the focus detection described using FIG. 5 displayed with respect to an object at a position where the user wishes to perform viewpoint movement within the range to be captured, the release switch included in the operation switch group 132 is half-press operated to perform focus adjustment. Accordingly, in the image displayed on the display device 131, the in-focus distance can be indicated to the user.

Also, the in-focus distance is set as the viewpoint movement distance. The method of setting the viewpoint movement distance is described here as being similar to that of automatic focusing (autofocus), but it may be performed in a similar manner to a manual focus operation, that is, manually operating the focus lens (the third lens group 105) of the focusing optical system. By the focus ring (not illustrated) provided on the focusing optical system being rotated, the in-focus distance is adjusted in the infinite direction or the close direction, adjusting the distance intended by the user as the viewpoint movement distance.

Also, marker direction adjustment is performed for setting the direction for performing viewpoint movement. The user changes the position of the marker (I(n,m)) for focus detection in the screen of the display device 131, moves the camera 100 via panning or the like, and aligns the marker with the direction they wish to perform viewpoint movement. Accordingly, the user can set the direction of the viewpoint movement while checking the image in the virtual space displayed on the display device 131.

In S3004, the CPU 1001 determines whether or not there has been a viewpoint movement operation instruction. When a viewpoint position change button included in the operation switch group 132 is pressed, the processing proceeds to S3005. In a case where the viewpoint position change button has not been pressed, the processing returns to S3003 and the focus and marker direction adjustment continues.

In S3005, the CPU 1001 determines whether or not viewpoint movement can be performed. By the user instructing to perform viewpoint movement via a press of the viewpoint position change button, the direction and distance in which the viewpoint is moved is determined. In a case where the post-movement viewpoint is below the ground (underground) of the background object, inside the foreground object, or the post-viewpoint-movement camera is interfering with another object, viewpoint movement is determined to be unable to be performed.

Also, in a case where the in-focus distance when the viewpoint position change button is pressed is at infinity, it is determined that the viewpoint cannot be moved to infinity. In a case where the viewpoint movement distance is equal to or farther than a predetermined distance, the viewpoint movement distance may be set again with a preset predetermined distance as the maximum value.

In S3006, in a case where the result of the viewpoint movement determination of S3005 is that viewpoint movement can be performed, the CPU 1001 advances the processing to S3007. On the other hand, in a case where viewpoint movement is determined to be unable to be performed, the processing proceeds to S3008. In S3007, viewpoint movement is performed for the viewpoint movement distance and direction set in S3003.

In S3008, the user is notified as a warning via the display device 131 that viewpoint movement cannot be performed. The user may be notified only that viewpoint movement cannot be performed, or the user may also be notified of this together with the reason such as interference with an object or the set movement distance being too far.

When the viewpoint movement in S3007 or the notification that viewpoint movement cannot be performed in S3008 is complete, the processing proceeds to S3009.

In S3009, the CPU 1001 ends the present subroutine after receiving an end instruction for the viewpoint movement mode. In a case where there is no end instruction for the viewpoint movement mode, the processing returns to S3003.

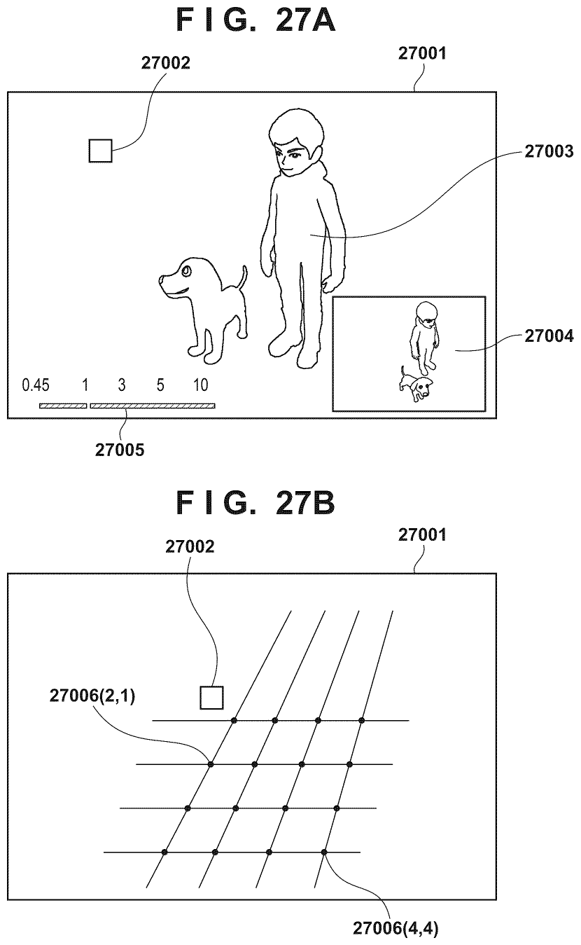

Next, a detailed example of the viewpoint movement subroutine described using FIG. 26 will be described using FIGS. 27A and 27B. FIGS. 27A and 27B illustrate display examples of the display device 131 in the viewpoint movement mode.

FIG. 27A illustrates a display example in which viewpoint movement setting in viewpoint movement mode is being performed in a virtual space in which a person and a dog are arranged as foreground objects. In a display screen 27001 of the display device 131, a foreground object 27003 of a person and a dog is displayed and, as the pre-viewpoint-movement state, the camera is arranged at a viewpoint from the left upper portion of the person.

27002 is one of the markers (I(n,m)) described using FIG. 5 and indicates the direction of movement of the viewpoint on the display screen. 27005 indicates the viewpoint movement distance together with the viewpoint movable range. In FIG. 27A, the movable range is from 0.45 m to 10 m, and the current adjustment distance is indicated to be 1 m. In the example of FIG. 27A, an object at a distance of 1 m from the current viewpoint position (camera position) is being focused on, and the in-focus distance and the out-of-focus distance are not represented in the diagram, with an in-focus state from close to infinity being displayed.

The marker 27002 can move within the display screen 27001. Also, by performing a panning or similar operation with the camera, the marker 27002 can be superimposed over an object such as the dog, and that distance can be set for the focus adjustment, that is, the viewpoint movement distance. A sub-display screen 27004 displays a preview image of when the foreground object 27003 is observed from the post-viewpoint-movement viewpoint currently set. from the post-viewpoint-movement viewpoint, which direction for the image to preview may be set automatically from the position information of the foreground object, or the user may be able to operate an operation switch. Also, in the sub-display screen 27004, a rectangular frame may be displayed indicating the range to be captured corresponding to the focal length of the lens being used.

In this manner, by using the screen displayed on the display screen 27001 and the marker 27002 to set the viewpoint movement distance and direction, the user can intuitively and easily perform viewpoint movement with an operation that is similar to that used when shooting.

A modification example of the viewpoint movement will now be described using FIG. 27B. This is a method of arranging a viewpoint movement target in the display screen as a target position and displayed so that the user can more easily perform viewpoint movement.

FIG. 27B illustrates a viewpoint movement target (target position, mark) being displayed in the display screen in the viewpoint movement mode. A viewpoint movement target 27006 is displayed in a grid-like pattern on the ground, which is a portion of the background object of the display screen 27001. At intersection points of the grid, the viewpoint movement target 27006 (2,1) is indicated at the 2nd row 1st column intersection point, and the viewpoint movement target 27006 (4,4) is indicated at the 4th row 4th column intersection point. The user can move the marker 27002 towards the viewpoint movement target 27006 close to the distance they wish to perform viewpoint movement and select it to select one of the intersection points and set the viewpoint movement distance. The viewpoint movement target may be superimposed with a foreground object and displayed or may be displayed together with a numerical value for the distance of the viewpoint movement target. In this manner, by displaying the viewpoint movement target, the user can more easily set the viewpoint movement distance.

Operational Feedback in Virtual Space Shooting via Driving of Camera Drive Unit Next, the operations of the camera when performing virtual space shooting will be described using FIG. 28. In shooting in a real space, in conjunction with operations relating to shooting, driving the shutter and driving the lens gives tactile feedback such as vibrations and sounds to the user, which leads to improving the quality of the image capturing experience. On the other hand, as described above, in virtual space shooting, the virtual subject tracking processing and the virtual space shooting are achieved by the operation of a release switch of the operation switch group 132 of the camera 100. At this time, no drive units are required for image generation, and the shutter and the lens do not need to be driven. Such a state may lead to a decrease in the quality of the image capturing experience. In the present embodiment, by driving the drive units of the camera 100 in synchronization with the operations in the virtual space shooting, tactile feedback such as vibrations and sounds is given to the user to achieve a more realistic image capturing experience.

FIG. 28 is a flowchart for describing the camera operations at the time of virtual space shooting. Each item of processing is executed by the camera CPU 121.

In S1201, the camera CPU 121 receives a camera drive unit initialization instruction from the CPU 1001 in S1002 in FIG. 13 and executes initialization of the camera drive unit. The open/closed state of the shutter 106 is driven according to the settings of the camera in the virtual space. For example, in a case where shooting is to be performed from then on, driving is performed to put the shutter in an open state. Also, the zoom actuator 111, the diaphragm actuator 112, and the focus actuator 114 are driven according to the field of view at the start time of virtual space shooting, the depth of field, the focal length and f-number corresponding to the in-focus distance, and the focus lens position. In the present embodiment, it has been described that the initial position of the drive unit of the camera 100 is set via an instruction from the CPU 1001. However, the initial state may be determined by the external computation apparatus 1000 via the output of position information of each drive unit of the camera 100 to the external computation apparatus 1000.

In S1202, the camera CPU 121 outputs the camera information, the lens information, and the operation information in a manner according to S1003 in FIG. 13. The contents of the information are as described in S1003.

In S1203, the camera CPU 121 obtains the image generated in S2000 of FIG. 13 and displays the image on the display device 131.

In S1204, the camera CPU 121 monitors whether a focus drive instruction for performing in S4015 of FIG. 16 has been input to the camera 100. In a case where a focus drive instruction has not been obtained, the processing proceeds to S1206. In a case where a focus drive instruction has been obtained, the processing proceeds to S1205. In S1205, the camera CPU 121 follows the focus drive instruction, and the focus actuator 114 drives the focus lens (the third lens group 105).

In S1206, the camera CPU 121 monitors whether the f-number input to the camera 100 in S5001 in FIG. 24 is different from the current setting. In a case where there is no change relating to the f-number, the processing proceeds to S1208. In a case where there is a change relating to the f-number, the processing proceeds to S1207.

In S1207, the camera CPU 121, according to the f-number change content, uses the diaphragm actuator 112 to drive the diaphragm 102.

In S1208, whether or not the time of detection of the switch Sw2 has been input to the camera 100 in S5001 of FIG. 24 is monitored. In a case where the time of detection of the switch Sw2 has not been input, the processing proceeds to S1210. In a case where the time of detection of the switch Sw2 has been input, the processing proceeds to S1209.

In S1209, the camera CPU 121 drives the shutter 106 in a similar manner to when shooting in a real space after a predetermined amount of time has passed from the input time of detection of the switch Sw2.

As described above, by driving the focus lens, the diaphragm, and the shutter in shooting in a virtual space, the user can be given feedback such as vibrations and sounds via the driving of the camera being operated, and a more realistic image capturing experience can be obtained.

In the present embodiment, the drive units of the camera 100 are driven according to an operation instruction relating to shooting in a virtual space. However, in some cases, the camera 100 may be unable to perform driving in response to the operation instructions provided. For example, in some cases, an operation instruction may be equal to or greater than the continuous shooting speed possible for the camera 100 to be driven at, and in other cases, the operation instruction may be for driving a focus lens for a longer distance than the mounted lens.

In such cases, based on the provided operation instruction, driving of the drive units of the camera 100 may be prohibited and the operation instruction may be edited. Then, after the instruction contents are changed so that driving of the drive units of the camera 100 can be performed, the drive units may be driven. For example, if there is an operation instruction equal to or greater than the continuous shooting speed of the camera 100, it is conceivable that the shutter is driven by downsampling operation instructions at certain intervals. Also, regarding diaphragm and focus driving, it is conceivable that the specifications of the lens used in a virtual space and the specifications of the lens mounted in a real space are compared and standardized to have the same driving range and that, when there is an operation instruction, the drive amount is also standardized in a similar manner.

In the present embodiment, operational feedback for the user has been described. However, the sounds and vibrations generated at this time may be recorded by another recording unit. For example, a shake corresponding to the vibration amount of the camera may be provided to a still image, or the generated sound may be recorded in a video. In this manner, shooting in a virtual space that is similar to shooting in a real space can be achieved.

### Image Capturing Result Shooting and Evaluation Method

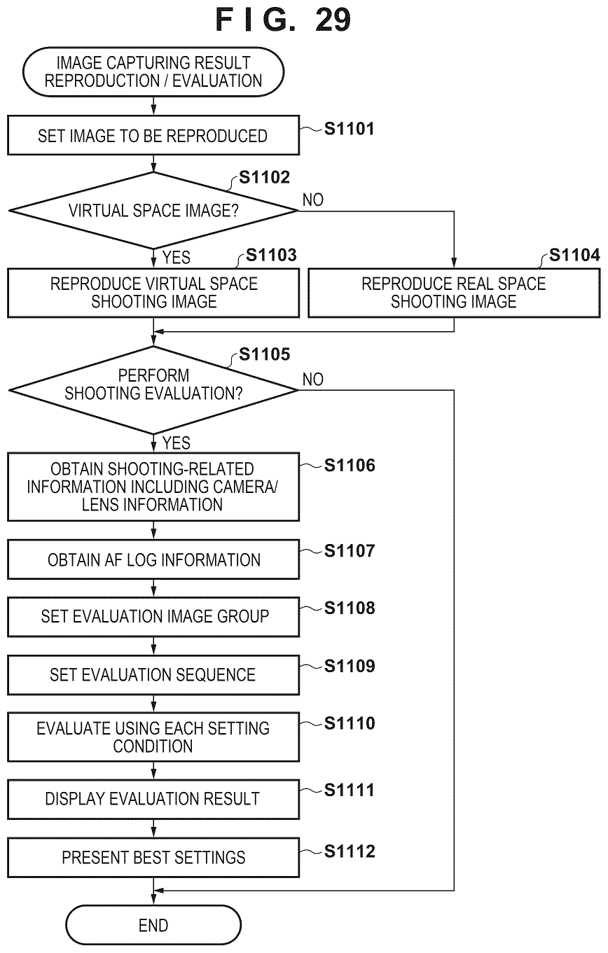

The flowchart of FIG. 29 illustrates a method for image reproduction and evaluation after shooting with the camera 100 according to the present embodiment. Specifically, in the reproduction a real space shooting image and the reproduction of a virtual space shooting image, display of a defocus map of an image and calculation of an in-focus degree of a consecutive sequence of images are performed under condition settings different from when actually shooting. Accordingly, display processing can be executed including the display of a cause of a degrading in-focus degree and a best settings suggestion for enhancement. Hereinafter, “S”denotes the term “step”.

First, in S1101, the camera CPU 121 selects an image for reproduction from the flash memory 133. By the user operating the operation switch group 132 for instructing reproduction, display of the most recently captured image or a previously reproduced image is performed. Thereafter, the user performs an operation to reproduce the desired image by operating the operation switch group 132.

In S1102, the camera CPU 121 determines whether the image to be reproduced is a virtual space captured image or a real space captured image. In a case where the camera CPU 121 determines that the image to be reproduced was captured in a virtual space, the processing proceeds to S1103, and reproduction of the virtual image stored in the storage unit 1004 of the external computation apparatus 1000 is performed on the display device 131. In a case where it is determined that the image is not a virtual space captured image and is a real space captured image, the processing proceeds to S1104, and reproduction of the image stored in the flash memory 133 is performed on the display device 131.

In S1105, the camera CPU 121 determines whether to perform shooting evaluation of the reproduced virtual space captured image (S1103) or the reproduced real space captured image (S1104) described above. In a case where shooting evaluation is to be performed, the processing proceeds to S1106. In a case where shooting evaluation is not to be performed, the present flow ends.

In S1106, the camera CPU 121 obtains the shooting-related information of when the image to be reproduced was captured. The shooting-related information corresponds to the settings of the camera to use and various types of information of the lens set when shooting. The shooting-related information includes, as lens and camera settings for when shooting, the focal length and f-number, the continuous shooting mode, the AF mode, the subject detection AF tracking settings, the AF frame settings, the shutter method, and the like. The shooting-related information is information used when evaluating the focus state of the image described below and may be any type of information as long as it affects the focus state. The shooting-related information may be stored in the flash memory 133 or the storage unit 1004 or may be attached to the image to be reproduced as meta information.

In S1107, the camera CPU 121 obtains AF log information attached to the image to be reproduced as meta information. The AF log information includes defocus information of when the reproduced image was captured, AF frame settings information, and tracking information (with a subject detection AF function, focusing on a detection object, for example, automatically detecting from an algorithm set for a person, animal, vehicle, or the like). Also included are servo AF characteristics (for setting focus priorities allocated to various types of parameters for the servo AF) and action recognition information (subject orientation information and information for subject recognition priority in a case where the subject has a specific movement). Also included are shutter method information (mechanical shutter mode for driving a mechanical shutter, electronic shutter mode for determining the exposure time with only an image sensor and not using a mechanical shutter, or a similar shutter mode is selected, and the settings information of the frame speed of continuous shooting such as 30, 20, 10 frames/second for the electronic shutter, for example, can be checked) and the like.

In S1108, the camera CPU 121 sets one or more images included in the images being reproduced as an evaluation image group. As the evaluation image group setting method, images captured at a time close to the capture time of the images being reproduced may be set or an image group captured in one continuous shooting may be set. Also, the image group can be set by setting the first and last of the evaluation image group.

In S1109, the camera CPU 121 performs setting of an evaluation sequence. The devices to use and the various types of algorithms are determined from the camera CPU 121 (in shooting in a virtual space, it may be the CPU 1001 of the external computation apparatus), and what kind of evaluation to perform is determined. The details will be described below.

In S1110, the camera CPU 121 performs evaluation using each setting condition. Evaluation is performed using the various types of information obtained from S1106 to S1109 described above and the conditions of the various types of setting content. Accordingly, for the image being reproduced, a defocus amount of the captured image is calculated from a focus control result different from that at a time of shooting, the offset amount of the focus is evaluated based on a threshold determined from the defocus amount, and the in-focus degree is calculated.

In calculating the in-focus degree, image analysis is also simultaneously performed, and an analysis of the cause of good or bad in-focus degree is also simultaneously performed. Also, the defocus amount is calculated from a focus control result different from that at a time of shooting, and a defocus map is generated and superimposed on the captured image.

Accordingly, the difference between the focus states of an image obtained by shooting with the condition settings at the time of image capture and an image obtained by shooting assuming different condition settings can be evaluated.

In S1111, the camera CPU 121 displays the result of the evaluation performed in S1110 on the display device 131 or an external display device such as a PC. The evaluation result display method is not limited to one format. The display method will be described below. By the evaluation result being displayed, the user can confirm the cause of the degradation in the in-focus degree. Accordingly, the shooting method can be corrected and the shooting settings changed, allowing for an improvement in the shooting technique.

In S1112, the camera CPU 121 presents the best setting. Based on the evaluation result of S1111, the best settings are presented from the evaluation results relating to the shooting in-focus degree. The presented contents will be described below and display examples will be given. With the best settings used here, the user checks the change of best settings displayed on the display device 131 and performs the change, but a menu may be provided for automatically determining whether to change settings using the evaluation result before performing evaluation is performed with the setting of the reproduced image of S1101. By change being automatically selected, a change to the best camera settings can be automatically performed based on the evaluation result.

Also, similar processing may be executed in parallel during shooting, and a settings change may be performed without confirmation from the user, for example, continuous shooting may be continued while automatically switching to optimal settings for the fourth image from the evaluation result of three images during continuous shooting.

### Defocus Map Display

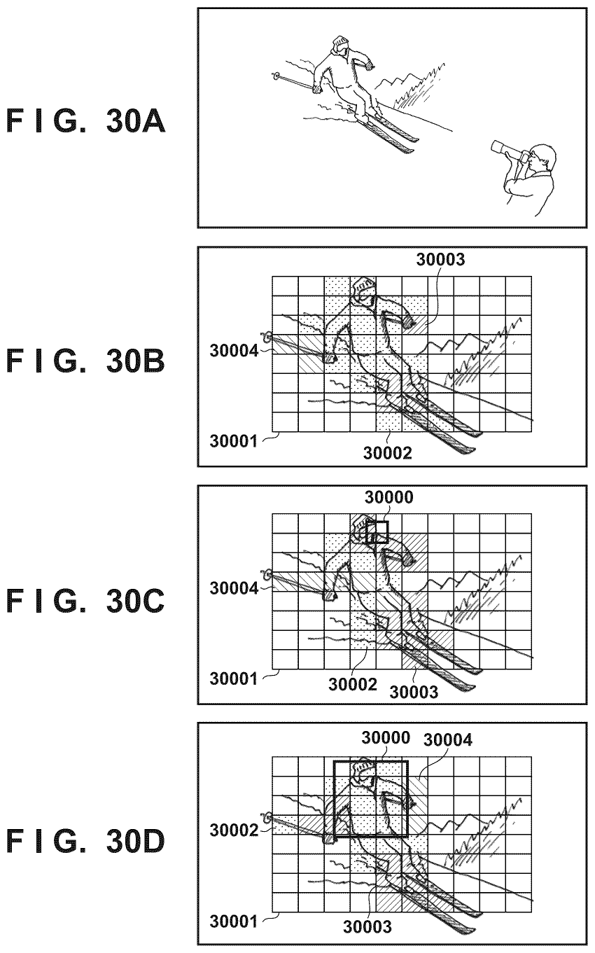

Next, a display with the defocus map superimposed on the captured image of S1111 will be described based on the evaluation result of S1110 using FIGS. 30A to 30D. FIG. 30A illustrates an example of a shooting scene of a person skiing.

In FIG. 30B, a defocus map 30001 based on the computations of the focus control result from the shooting-related information of the meta information attached to the captured image is displayed superimposed on the captured image. In the defocus map, for each block displayed in the 10×8 grid, whether the focus position of the focus is a positive direction (front focus) or a negative direction (back focus) with respect to 0 is displayed on the captured image.

A frame 30002 with a rhomboid pattern displayed in each block indicates that the focus position is at or near 0 and that the subject is in-focus.

A frame 30003 with a diagonal line pattern displayed in each block indicates a positive defocus amount state and a front focus tendency.

A frame 30004 with a dot pattern displayed in each block indicates a negative defocus amount state and a back focus tendency.

Blocks overlapping the skier are mostly displayed with the rhomboid pattern frame 30002, indicating that the subject is in-focus.

FIG. 30B is an example, and the defocus map does not need to be a 10×8 grid, and a more detailed display may be used. The defocus amount of an area mostly encompassing the main subject is displayed, but no such limitation is intended, and a defocus amount may be displayed in the entire captured image.

In FIG. 30C, the defocus map 30001 based on the computations of the focus control result from the shooting-related information of the meta information attached to the captured image captured by a combination of the camera (product name CA) and lens (product name LA) used to shoot by the user is displayed superimposed on the captured image.

An AF frame 30000 is the result of shooting with the condition using only one point as the focus detection area from the AF frame settings information of the camera. From the evaluation result of the state in which the AF frame is covering half of the face of the subject, it can be seen that the contrast of the subject of the background has affected the image, and the focus is farther beyond the main subject. Thus, the in-focus degree is degraded. As seen from the defocus amount of the focus position of each block, the right side of the subject is displayed with diagonal lines corresponding to a front focus tendency.

In FIG. 30D, the defocus map captured by a combination of the camera (product name CA) and lens (product name LA) used to shoot by the user as described above is illustrated.

The defocus result in a case where the AF frame 30000 is changed to a wider range AF from the one-point AF described above in the evaluation sequence setting performed in S1109 is illustrated.

In S1110, the defocus amount is calculated based on the focus control information of the one-point AF frame of the AF frame settings information actually captured and the focus control information after the change to a wider range AF frame. Then, the result is illustrated in FIGS. 30C and 30D as the defocus map 30001.

By displaying the change in the defocus map 30001 due to the change in the AF frame setting, the defocus amount at the time of a one-point AF and the defocus amount at the time of an AF with a wider area can be compared. In FIG. 30D, many of the frames 30002 with the rhomboid pattern are superimposed on the subject, meaning that the image has not been affected by the background and an image with an in-focus subject is obtained. In the examples illustrated in FIGS. 30A to 30D, via the framing technique of the user, we can see that shooting with an AF frame setting of an AF with an area wider than a one-point AF allows for a better defocus result to be obtained.

In addition to the AF frame change, information necessary for the AF is obtained from the virtual camera information and the existing lens information for a camera (product name CB) different from the camera (product name CA). Also, by rewriting the focus-related information of a captured image with the focus control information of the camera (product name CB), the difference in AF performance between the camera (product name CA) and the camera (product name CB) can be compared. Accordingly, in a case where a new product or the like is expected to have improved performance, the degree of performance improvement can be evaluated per shooting scene. This can be used in researching whether to buy a new product.

Also, in a similar manner, from the lens (product name LA) to a different lens (product name LB), lens information of a virtual lens different from the lens used in the reproduced image is obtained. Then, the virtual defocus amount of different combinations of focal lengths, f-numbers, and the like can be obtained for the reproduced image. As a result, the defocus information of the virtual lens (product name LB) and the defocus information of the image captured using the lens (product name LB) can be compared, and the performance after the lens is changed can be displayed and checked.

These displays may be on the display apparatus of an external PC instead of the display device 131 of the camera 100. The method for comparing the changed defocus map image may include lining up the before and after images or may include changing only the defocus amount of the defocus map.

The defocus amount of FIGS. 30A to 30D is displayed by dividing the focus position into three levels of in or near focus, front focus, and back focus. However, a more detailed division may be used, or the defocus amount may be displayed in units such as mm.

By changing the focus control result based on the information of a camera and lens different from the camera and lens used in shooting, the user can check the difference in performance. Also, since the user can check the performance of a desired camera or lens before purchase, the user can select the camera or lens that matches their wishes.

Shooting in a real space has been described using FIGS. 30A to 30D. However, the same may be applied to an image obtained by shooting in a virtual space using the external computation apparatus 1000 and not only the real space.

### In-Focus Degree

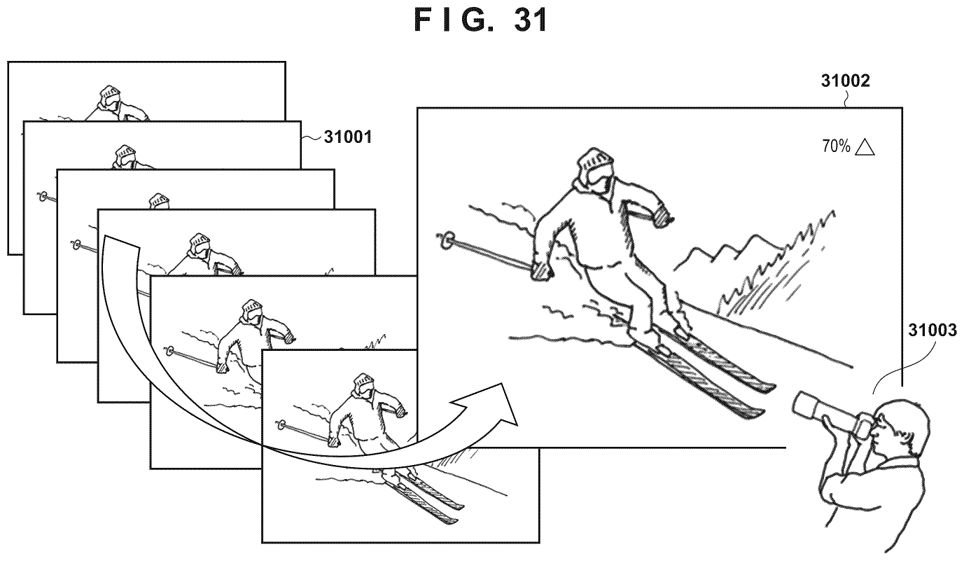

FIG. 31 illustrates an example of calculating the in-focus degree for a sequence of images obtained via continuous shooting based on the result of the shooting evaluation flow illustrated in FIG. 29.

FIG. 31 illustrates a user 31003 capturing a plurality of images of a sequence of scenes of a subject skiing via continuous shooting and obtaining images 31001. The images here may be images shot in a real space or images shot in a virtual space. The defocus amount is calculated from an evaluation result S1110 of the plurality of captured images of the shot sequence, and from the calculated result, in a case where the defocus amount is within a predetermined threshold range centered on a defocus amount of 0, the in-focus degree is determined as ∘, otherwise the in-focus degree is determined as ×. Determination of either ∘ or × is performed for each image, and the ratio of ∘ for all of the captured images obtained via the sequence of continuous shooting is displayed as an in-focus degree display 31002.

FIG. 31 illustrates an example in which the ratio of in-focus degrees that passed is 70%, with Δ indicating a determination that there is room for improvement. The in-focus degree result for the sequence is displayed as 70% Δ, but the determination result of the in-focus degree may be displayed in a manner that is easier for the user to understand by just displaying ∘ when the in-focus degree is 80% or greater.

Also, when the in-focus degree result is 60% or less, × is displayed. However, the display of the symbol may be freely set, and only the in-focus degree may be displayed without the symbol.

In the present embodiment, the calculation result of the in-focus degree is displayed via two levels ∘ and ×. However, the in-focus degree determination method here is just an example, and the method may be freely determined. The variance or the like may be displayed using the defocus computation unit mm. The display method also does not have detailed settings, and the display may be freely displayed. The in-focus degree result of the sequence is displayed on the display device 131 of the camera, but the result can be checked on another display apparatus such as a PC.

### List of Setting Item Changes

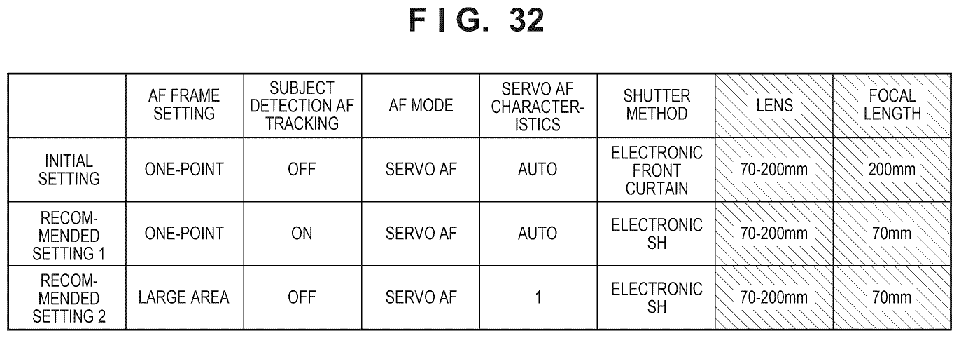

FIG. 32 is a table illustrating examples of items and evaluation conditions with settings that can be changed for the evaluation in S1110 for the setting change suggestion. In the horizontal direction, examples of items with settings that can be changed are displayed.

The items in white frames are examples of setting items of the camera information, and displayed are AF frame setting, subject detection AF tracking, AF mode for switching between one-shot AF and servo AF, servo AF characteristics for changing the various types of parameters for servo AF, and shutter method. The grey frames are examples of setting items of the lens information, and displayed are lens and focal length.

FIG. 32 illustrates the initial settings for the shooting settings when obtaining an image. A recommended setting 1 and a recommended setting 2 indicate examples of an evaluation sequence set in S1109 of FIG. 29. The number of evaluation sequences is not limited to two. By changing to all of the combinations of the parameters with settings that can be changed and performing the evaluation of S1110, the best settings (evaluation sequence) for maximizing the in-focus degree can be found. However, as the computation load is increased, only the parameters that are effective in enhancing the in-focus degree may be changed so that the computation load is reduced.

Settings that are effective in enhancing the in-focus degree will now be described using the recommended settings of FIG. 32.

The following situations are conceivable reasons for why the AF frame may separate from the subject with the initial settings set by the user. In the combination of one-point AF and tracking off, the AF frame seen in the finder is fixed. Thus, the user needs to continuously align the AF frame with the subject, and if the difficulty of the movement of the subject increases unexpectedly, framing becomes difficult.

With the recommended setting 1, even with one-point AF, since tracking AF is turned on for use, subject detection is performed. Thus, the AF frame automatically catches the subject and can continuously track the subject. Thus, as long as the user starts tracking with the AF frame on the subject when starting shooting, the user can simply concentrate on putting the subject in the field of view, reducing the framing difficulty. The setting relating to the AF frame and the subject detection AF tracking can be changed and evaluated for an image captured in a real space or for an image captured in a virtual space. Using an image and the defocus map information of when the image was obtained, the algorithm of the AF frame setting to be applied after change can be used to allow a new AF frame to be selected. Also, an algorithm or the like relating to tracking to be applied after change can be used on the image to perform setting of a new subject detection area.

In a similar manner, with the recommended setting 2, a setting of a large area AF with a large AF range is set for the one-point AF. With such a setting, the framing difficulty can be reduced without using tracking.

For the shutter method, since the shutter curtain is driven at each release, a blackout occurs with the electronic front curtain. Since a blackout occurs, the subject is momentarily lost and the display update rate is also reduced. This makes framing difficult. An electronic shutter does not use a shutter curtain. Thus, the display update rate during continuous shooting is not reduced, and a blackout causing a total black screen display does not occur. Accordingly, in the case of continuous shooting of a subject in particular, an electronic shutter can reduce the framing difficulty without losing the subject.

Regarding the shutter method setting, for an image captured in a real space, a change in the direction in which the frame speed slows (downsampling images) can be changed. However, changing the direction for speeding up the frame speed is difficult as there is no information. Since image generation in a shooting environment can be performed again for images captured in a virtual space, a change in the direction for speeding up the frame speed can be performed. Thus, when evaluation is performed on an image captured in a real space, in a case where the frame speed using an electronic front curtain shutter or the like is slow, the user may be recommended to use an electronic shutter using other information such as the captured subject speed or the like.

Regarding the lens focal length, the user uses a zoom lens of from 70 mm to 200 mm and the focal length is aligned at 200 mm at the time of shooting. Thus, with respect to the subject, the field of view is narrow and unexpected subject movement and quick skiing movement tends to put the subject out of frame. This makes framing difficult. Widening the field of view gives more room in the field of view for unexpected movement and quick skiing movement of the subject, thus reducing the possibility of the subject going out of frame. Accordingly, by setting the focal length to 70 mm on the wide side, the framing difficulty can be reduced.

Regarding the focal length setting, a change of the direction for narrowing the field of view can be performed for an image captured in a real space. However, a change of the direction for widening the field of view is difficult as there is no information (image). Since image generation in a shooting environment can be performed again for images captured in a virtual space, a change in the direction for widening the field of view can be performed. Thus, when evaluation is performed on an image captured in a real space, in a case where shooting was performed with a long focal length, the user may be recommended to use a lens with focal length with a wider angle using other information such as the captured subject speed or the like.

As described above, for settings causing a reduction in the in-focus degree, by changing the setting content, a recommended setting that can efficiently enhance the in-focus degree can be found, allowing the computation load to be reduced.

The setting method of FIG. 32 is merely an example, and there are various methods that can be used for setting. An analysis of the shooting environment, such as whether the subject type is a person or an animal, whether a plurality of subjects are intersecting in the scene, or the like, can also be used. Also, the skill of the user may be determined from shooting history input in advance or from the movement of the subject and the framing by the user at the time of shooting to narrow down the recommended settings.

### Description of Information Display Relating to Shooting Setting

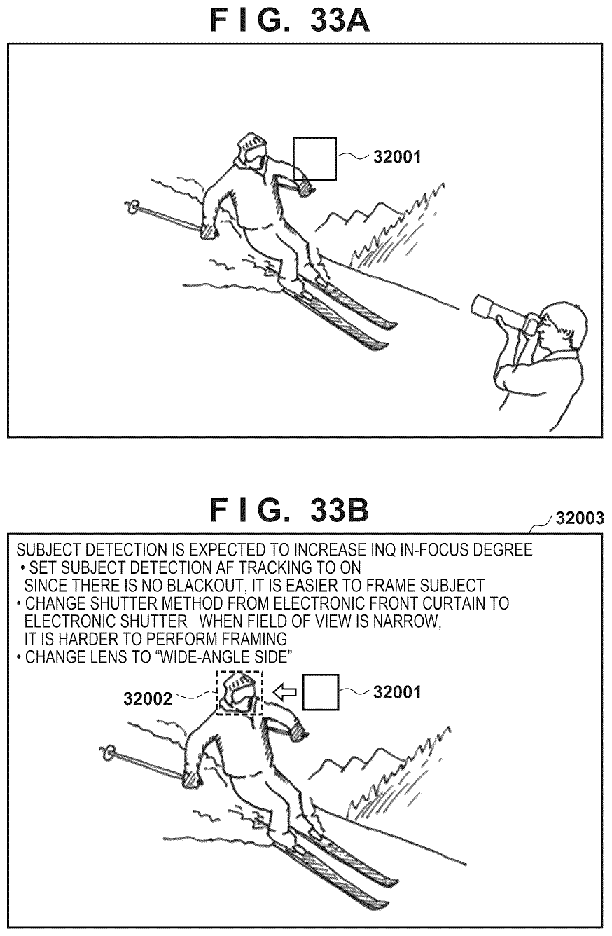

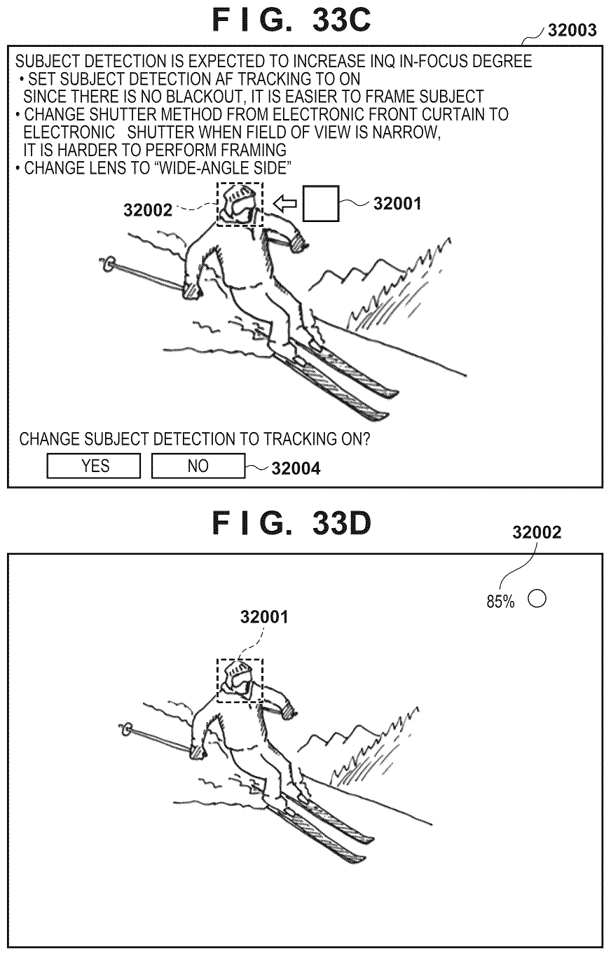

Next, information display for a captured image relating to the framing technique of the user from the in-focus degree evaluation result described above will be described using FIGS. 33A to 33D.

FIG. 33A illustrates an out-of-focus image with a large defocus amount and determined as a fail for the in-focus degree result in the evaluation result S1111 of the captured images from a sequence of continuous shooting. In the image, the framing has not kept up with the movement of the subject skiing at high speed and an AF frame 32001 has separated from the face of the subject. Thus, a degradation of the in-focus degree is expected. With the condition of the camera settings set by the user, framing in terms of the AF frame selection, the field of view via the lens focal length, and the like is presumed to be difficult. In such a situation, via image evaluation at the time of image reproduction, a best settings suggestion is displayed on the display device 131 of the camera or the display apparatus of a PC or the like. The best settings suggestion and display will be described next using FIG. 33B.

FIG. 33B illustrates an example displaying a suggestion to the user for the best settings as a result of evaluating various shooting sequences.

In the evaluation of various setting conditions in S1110, not only evaluation, but many types of conditions from making different combinations from the information and the setting conditions from S1106 to S1109 are calculated, and the setting condition with the highest in-focus degree is found.

Compared to FIG. 33A in which the AF frame 32001 has separated from the subject, in the evaluation of S1110, the in-focus degree when the AF frame is widened from the AF frame setting of the AF log information of S1107 is calculated. The in-focus degree of when the subject detection AF tracking information is added without changing the AF mode is confirmed. Various types of other conditions are switched to and the in-focus degree is calculated. From among these, the combination of settings with the highest in-focus degree is selected.

In the examples of FIGS. 33A to 33D, it is expected that the following conditions result in an increase in the in-focus degree from the result of the in-focus degree of various types of conditions in the evaluation result of S1110 of the captured image.
(1) The AF frame is not changed from one-point, and subject detection AF tracking is changed to on.
(2) The shutter method is changed to electronic shutter.
(3) The field of view is changed to a wide-angle side.

The best information can be suggested to the user based on the evaluation result of S1110 described above. A display 32003 displays the best information with respect to the cause described above.

FIG. 33C illustrates a display 32004 for making the user select whether or not to change the tracking regarding the subject detection of shooting-related information of the best settings suggestion of FIG. 33B described above. The user checks the display and can perform setting that can enhance the in-focus degree.

Next, though not illustrated, whether or not to change the shutter method is displayed and a display for making the user select is displayed in a similar manner. In the case of shooting in a real space, a selection cannot be made for the lens field of view. Thus, the user is advised to change the focal length via a display. In the case of shooting in a virtual space, the focal length can be virtually changed. Thus, as in FIG. 33C, a display relating to change is performed and the user is prompted to make a selection.

Note that regarding the method and order for displaying these settings change suggestions, the various types of settings may be displayed all at once and selected. Also, only the in-focus degree may be displayed, and the settings may be changed all at once to calculate to the in-focus degree selected by the user.

Here, a display that prompts the user has been described, but the settings described above may be automatically changed by the camera.

FIG. 33D illustrates a display of the evaluation result of shooting with the settings changed as in FIG. 33C.

The AF frame 32001 changes to a dotted line tracking AF frame, and as a result of the subject detection, the subject is now tracked at all times, allowing the user to concentrate on the framing.

By also changing the shutter method to an electronic shutter, blackouts no longer occur and the subject can be seen in the finder at all times. This reduces how often the subject is lost. The lens is changed to 70 mm on the wide side, giving more room for the subject in the field of view. This reduces how often the subject goes out of frame. As a result of the change to the best settings, the in-focus degree becomes 85%, indicating a dramatic improvement from the 70% of before change.

By evaluating the captured sequence of images and converting the in-focus degree into numerical values, the user can understand the capability of framing techniques. Analyzing the causes of degradation in the in-focus degree and displaying the best settings can lead to an improvement in the framing technique of the user.

FIGS. 33A to 33D has been described using an example of real space shooting. However, as with FIG. 31, evaluation can be performed from the in-focus degree of results of shooting in a virtual space environment used by the external computation apparatus 1000 and not only the real space, so that the best settings may be displayed and the shooting settings may be changed or automatically changed.

### MODIFIED EXAMPLE

In the present embodiment, a configuration has been described in which the detection of a focus area is implemented by area detection based on machine learning. However, the focus area detection method is not limited thereto. For example, the focus area can be set using the aspect ratio of the subject detection area, the size of the subject detection area, the depth information of the subject using a defocus map, and the like.

### Second Embodiment

The second embodiment will be described next. In the present embodiment, in the virtual space image generation and output processing, virtual space image generation and output are performed also using real space captured images. The configuration of the imaging system 10 according to the present embodiment is the same as in the first embodiment, but a portion of the virtual space image generation and output processing is different. Here, the differences from the first embodiment in the virtual space image generation and output processing will be the focus of the description.

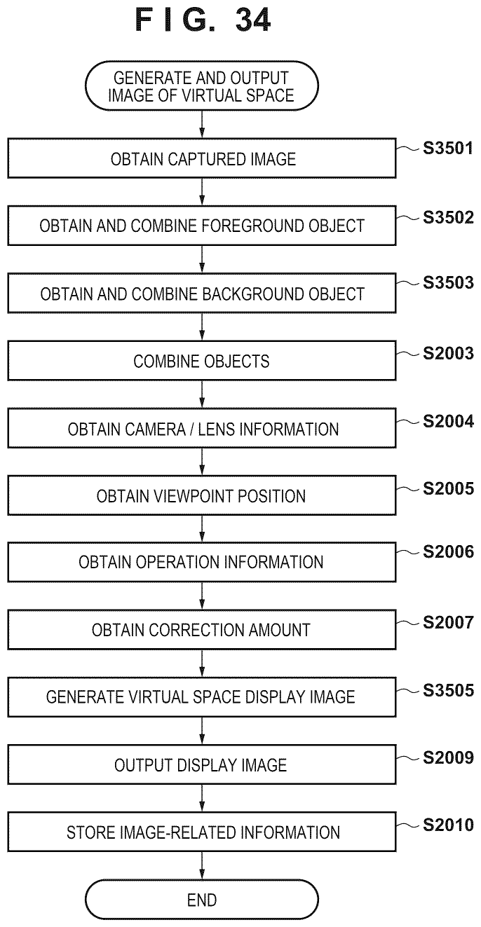

The virtual space image generation and output processing according to the second embodiment will now be described using the virtual space image generation and output processing sub-flowchart of FIG. 34.

In S3501, the CPU 1001 obtains a captured image. The captured image may be an image captured via real space shooting processing as described above or may be a captured image captured in advance.

In S3502, the CPU 1001 obtains the foreground object and performs combining. Using a trained model for estimating the three-dimensional model of the image, a three-dimensional model of the subject may be generated from the real space captured image and combined with a three-dimensional model of the subject in the virtual space as described above. For example, a face may be obtained as the foreground object from the real space captured image and another site such as the torso or the like may be obtained from the foreground object storage unit 1101 of the virtual space reproduction apparatus 1100. In another method, a three-dimensional model of the subject from a captured image and a three-dimensional model of the subject in the virtual space described above may be alternately obtained along a time series, allowing them to be displayed at different timing as a display image in the virtual space as described below. Also, a foreground object in a virtual space may be obtained and combined with a captured image in a real space at the stage of virtual space display image generation in S3503 described below.

In S3503, the CPU 1001 obtains the background object and performs combining. As when obtaining the foreground object in S3502, a three-dimensional model may be generated from the captured image, and combining may be performed separating the area and the virtual space background object obtained by the background object obtaining unit 1105 as the background object. In another method, the background object from the captured image and the virtual space background object may be separated on a time series. Also, a background object in a virtual space may be obtained and combined with a captured image in the virtual space display image generation in S3505 described below.

In S3505, the CPU 1001 performs virtual space display image generation. In a case where the foreground object and the captured image with the background object are combined, processing similar to the virtual space display image generation processing of S2008 in FIG. 15 according to the first embodiment is executed. When a display image is generated by combining the virtual space foreground object, the background object, and the captured image, the captured image is aligned with the display image generated from the virtual space foreground object and the background object and these are combined to generate the display image. For example, only the face portion of the subject of the captured image is extracted and combined with the virtual space display image.

Also, in a case where the image range and viewpoint position is different due to a different field of view from the captured image, in advance, a trained model for estimating a three-dimensional model for the image is used, a three-dimensional model is generated from the captured image, the image range and viewpoint position are changed, and a display image is generated. Then, by dividing the virtual space display image into areas and performing combining, a virtual space display image including the captured image also is generated.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-139155, filed Aug. 20, 2024, which is hereby incorporated by reference herein in its entirety.

What is claimed is:

1. An image generation apparatus comprising at least one processor or circuit and a memory storing instructions to cause the at least one processor or circuit to perform operations of the following units:
a generating unit that generates a virtual space image,
a first obtaining unit that obtains operation information for a camera of a user,
a second obtaining unit that obtain information relating to the camera,
a third obtaining unit that obtains information relating to a subject, and
a changing unit that changes correction for the virtual space image captured with the camera, based on at least one of the information obtained from the first to third obtaining units.

2. The image generation apparatus according to claim 1, wherein
the changing unit changes a correction amount of the correction, based on at least one of the information obtained from the first to third obtaining units.

3. The image generation apparatus according to claim 1, wherein
the changing unit changes whether or not to perform the correction, based on at least one of the information obtained from the first to third obtaining units.

4. The image generation apparatus according to claim 1, wherein
the operation information for the camera includes operation information for a lens mounted in the camera.

5. The image generation apparatus according to claim 1, wherein
the information relating to the camera includes information relating to a lens mounted in the camera.

6. The image generation apparatus according to claim 1, wherein
the changing unit changes the correction, based on information of an image captured before a timing of when shooting is to be performed.

7. The image generation apparatus according to claim 1, wherein
the changing unit determines an intention of a user from operation information of the user, and changes the correction based on the intention of the user.

8. The image generation apparatus according to claim 1, wherein
the operation information is information of at least one operation from among a framing operation, a zooming operation, and a focusing operation.

9. The image generation apparatus according to claim 1, wherein
the changing unit changes the correction based on shooting difficulty.

10. The image generation apparatus according to claim 9, wherein
the changing unit determines shooting difficulty based on at least one information from among speed, acceleration, angular velocity, angular acceleration, and size of a subject; a contrast value of subject, and a distance between a subject and a user.

11. The image generation apparatus according to claim 9, wherein
the changing unit decreases a correction amount for the correction as shooting difficulty is higher.

12. The image generation apparatus according to claim 9, wherein
the changing unit increases a correction amount for the correction as shooting difficulty is higher.

13. An image generation method comprising:
generating a virtual space image;
executing first obtaining to obtain operation information for a camera of a user;
executing second obtaining to obtain information relating to the camera;
executing third obtaining to obtain information relating to a subject; and
changing correction for the virtual space image captured with the camera, based on at least one of the information obtained in the first to third obtaining.

14. A non-transitory computer-readable storage medium storing a program for causing a computer to execute each step of an image generation method, the method comprising:
generating a virtual space image;
executing first obtaining to obtain operation information for a camera of a user;
executing second obtaining to obtain information relating to the camera;
executing third obtaining to obtain information relating to a subject; and
changing correction for the virtual space image captured with the camera, based on at least one of the information obtained in the first to third obtaining.
